(19) United States
(12) Patent Application Publication
(10) Pub. No.: US 2026/0299648 A1
(43) Pub. Date: Oct. 1, 2026

(54) DISPLAY DEVICE AND ELECTRONIC DEVICE INCLUDING THE SAME

(71) Applicant: Samsung Display Co., Ltd., Yongin-si (KR)

(72) Inventors: Yunyoung LEE, Yongin-si (KR); Sanghyo PARK, Yongin-si (KR); Insoo PARK, Yongin-si (KR)

(73) Assignee: Samsung Display Co., Ltd., Yongin-si (KR)

(21) Appl. No.: 19/631,553

(22) Filed: Mar. 27, 2026

(30) Foreign Application Priority Data
Mar. 31, 2025 (KR) 10-2025-0041388
Sep. 15, 2025 (KR) 10-2025-0131559

(51) Int. Cl. G06F 1/16

(52) U.S. Cl. CPC G06F 1/1656; G06F 1/1641; G06F 1/1681

(57) ABSTRACT

A display device includes a display unit; a frame supporting the display unit, the frame being under the display unit; a case accommodating the display unit and the frame; and a hinge assembly including a hinge cover, a first hinge module, and a second hinge module, the first hinge module is seated on the hinge cover and is configured to control the rotation of the frame, and the second hinge module is seated on the hinge cover and is configured to control the rotation of the case.

### CROSS-REFERENCE TO RELATED APPLICATIONS

This application claims priority under 35 U.S.C. § 119 to Korean Patent Application No. 10-2025-0041388, filed on Mar. 31, 2025, and Korean Patent Application No. 10-2025-0131559, filed on Sep. 15, 2025, each filed in the Korean Intellectual Property Office, the disclosure of each of which is incorporated by reference herein in its entirety.

### BACKGROUND

### 1. Field

One or more example embodiments relate to a display device and an electronic device including the same, and more particularly, to a display device including a hinge assembly and an electronic device including the display device.

### 2. Description of the Related Art

Display devices display images to provide users with visual information. Recently, flexible display devices have drawn attention. Such devices use materials with flexible properties to enhance their portability and/or space utilization while providing a wide display screen. As an example, bendable display devices including display panels that may be bent, rollable display devices including display panels that may be rolled, and foldable display devices including display panels that may be folded are under development.

A foldable display device may include a hinge assembly. The flexible display device may be folded according to a folding operation of the hinge assembly. In addition, the flexible display device may be unfolded according to an unfolding operation of the hinge assembly.

### SUMMARY

One or more example embodiments include a display device with improved quality.

One or more example embodiments include an electronic device including the display device.

Example embodiments of the present inventive concepts are not limited to the above example embodiments but may variously extend without departing from the scope and area of the present inventive concepts.

Additional example embodiments will be set forth in part in the description which follows and, in part, will be apparent from the description, or may be learned by practice of the presented example embodiments of the present inventive concepts.

According to one or more example embodiments, a display device includes a display unit; a frame supporting the display unit, the frame being under the display unit; a case accommodating the display unit and the frame; and a hinge assembly including a hinge cover, a first hinge module, and a second hinge module, the first hinge module and the second hinge module being seated on an inner surface of the hinge cover, the frame is configured to rotate around a frame rotational axis in the first hinge module, the case is configured to rotate around a case rotational axis in the second hinge module, an inter-axis distance is in a range of about 400 μm to about 600 μm, a frame rotational axis distance is defined as a distance between the frame rotational axis and an outer surface of the hinge cover, a case rotational axis distance is defined as a distance between the case rotational axis and the outer surface of the hinge cover, and the inter-axis distance is obtained by subtracting the case rotational axis distance from the frame rotational axis distance.

In some example embodiments, the case may include a first case on one side of the hinge cover, and a second case on another side of the hinge cover.

In some example embodiments, the second hinge module may be configured to control a rotation of the first case and a rotation of the second case.

In some example embodiments, the frame may include a first frame on one side of the hinge cover, and a second frame on another side of the hinge cover.

In some example embodiments, the first hinge module may be configured to control a rotation of the first frame and a rotation of the second frame.

In some example embodiments, the case may include a first through hole, the second hinge module may include a second through hole, and the case and the second hinge module may be coupled to each other by a coupling member inserted into the first through hole and the second through hole.

In some example embodiments, the frame may include a third through hole, the first hinge module may include a fourth through hole, and the frame and the first hinge module may be coupled to each other by a coupling member inserted into the third through hole and the fourth through hole.

In some example embodiments, the frame may be in contact with a lowermost end of the display unit.

In some example embodiments, the case may be in contact with an uppermost end of the display unit.

In some example embodiments, the display unit may include a metal plate, a display panel on the metal plate, a cover window on the display panel, and a protective film on the cover window.

In some example embodiments, the frame may be in contact with the metal plate, and the case may be in contact with the protective film.

In some example embodiments, the case may include a bottom portion and a lateral portion extending from the bottom portion.

In some example embodiments, the bottom portion of the case may include a coupling hole that accommodates at least a portion of the frame.

In some example embodiments, the frame may include a flat portion in contact with the display unit, and a protruding portion protruding from the flat portion and accommodated by the coupling hole.

In some example embodiments, a width of the protruding portion in a first direction may be less than a width of the coupling hole in the first direction.

In some example embodiments, the protruding portion may be configured to move in the first direction within the coupling hole according to a folding operation of the hinge assembly.

In some example embodiments, the frame may be fixed to the case through a washer within the coupling hole.

In some example embodiments, the case may include a bottom portion and a lateral portion extending from the bottom portion.

In some example embodiments, a planar separation distance between an end of the frame and the lateral portion of the case may increase according to a folding operation of the hinge assembly.

In some example embodiments, the display unit may include a metal plate, a display panel attached to an upper surface of the metal plate by a first adhesive member, a cover window attached to an upper surface of the display panel by a second adhesive member, and a protective film attached to an upper surface of the cover window by a third adhesive member and fixed to the lateral portion of the case.

In some example embodiments, according to a folding operation of the hinge assembly, each of a planar separation distance between an end of the first adhesive member and the lateral portion of the case, a planar separation distance between an end of the second adhesive member and the lateral portion of the case, and a planar separation distance between an end of the third adhesive member and the lateral portion of the case may increase.

In some example embodiments, the case may include a bottom portion and a lateral portion extending from the bottom portion.

In some example embodiments, the lateral portion of the case may include a groove that accommodates at least a portion of the frame.

In some example embodiments, the frame may include a central portion in contact with the display unit, and an extension portion extending from the central portion and accommodated in the groove.

In some example embodiments, the extension portion may move within the groove according to a folding operation of the hinge assembly.

In some example embodiments, the hinge assembly may be seated on the hinge cover, and the display device may further include a third hinge module configured to control rotation of the frame.

In some example embodiments, the first hinge module and the third hinge module may be apart from each other with the second hinge module therebetween.

According to one or more example embodiments, a display device includes a display unit; a frame supporting the display unit, the frame being under the display unit; a case accommodating the display unit and the frame; and a hinge assembly including a hinge cover, a first hinge module, and a second hinge module, the first hinge module is seated on an inner surface of the hinge cover, a lowermost end of the display unit is rotatably coupled to the first hinge module, the second hinge module is seated on the inner surface of the hinge cover, and an uppermost end of the display unit is rotatably coupled to the second hinge module, the frame is configured to rotate around a frame rotational axis in the first hinge module, the case is configured to rotate around a case rotational axis in the second hinge module, an inter-axis distance is in a range of about 400 μm to about 600 μm, a frame rotational axis distance is defined as a distance between the frame rotational axis and an outer surface of the hinge cover, a case rotational axis distance is defined as a distance between the case rotational axis and the outer surface of the hinge cover, and the inter-axis distance is obtained by subtracting the case rotational axis distance from the frame rotational axis distance.

In some example embodiments, the frame may be in contact with the lowermost end of the display unit, and the case may be in contact with the uppermost end of the display unit.

In some example embodiments, the display unit may include a metal plate, a display panel on the metal plate, a cover window on the display panel, and a protective film on the cover window.

In some example embodiments, the frame may be in contact with the metal plate.

In some example embodiments, the case may be in contact with the protective film.

In some example embodiments, the case and the second hinge module may be coupled to each other.

In some example embodiments, the frame and the first hinge module may be coupled to each other.

According to one or more example embodiments, an electronic device includes a display unit; a frame supporting the display unit, the frame being under the display unit; a case accommodating the display unit and the frame; a hinge assembly including a hinge cover, a first hinge module, and a second hinge module, the first hinge module is seated on an inner surface of the hinge cover, the frame is rotatably coupled to the first hinge module, the second hinge module is seated on the inner surface of the hinge cover, and the case is rotatably coupled to the second hinge module; and a memory storing data information, the frame is configured to rotate around a frame rotational axis in the first hinge module, the case is configured to rotate around a case rotational axis in the second hinge module, an inter-axis distance is in a range of about 400 μm to about 600 μm, a frame rotational axis distance is defined as a distance between the frame rotational axis and an outer surface of the hinge cover, a case rotational axis distance is defined as a distance between the case rotational axis and the outer surface of the hinge cover, and the inter-axis distance is obtained by subtracting the case rotational axis distance from the frame rotational axis distance.

In some example embodiments, the case may include a first case on one side of the hinge cover, and a second case on another side of the hinge cover.

In some example embodiments, the second hinge module may be configured to control a rotation of the first case and a rotation of the second case.

In some example embodiments, the frame may include a first frame on one side of the hinge cover, and a second frame on another side of the hinge cover.

In some example embodiments, the first hinge module may be configured to control a rotation of the first frame and a rotation of the second frame.

These and/or other aspects will become apparent and more readily appreciated from the following detailed description of the example embodiments, the accompanying drawings, and claims.

### BRIEF DESCRIPTION OF THE DRAWINGS

The above and other aspects, features, and advantages of some example embodiments of the present inventive concepts will be more apparent from the following description taken in conjunction with the accompanying drawings, in which:

FIG. 1A is a perspective view of a display device in an unfolded state according to some example embodiments;

FIG. 1B is a perspective view of the display device of FIG. 1A in a folded state according to some example embodiments;

FIG. 2A is a perspective view of a display device in an unfolded state according to some example embodiments;

FIG. 2B is a perspective view of the display device of FIG. 2A in a folded state according to some example embodiments;

FIGS. 3 and 4 are cross-sectional views of a plurality of elements included in the display device of FIGS. 1A and 1B according to some example embodiments;

FIG. 5 is a schematic plan view of a hinge assembly according to some example embodiments;

FIG. 6 is a schematic front perspective view of a hinge cover, a second hinge module, a fourth hinge module, and a case according to some example embodiments;

FIG. 7 is a schematic rear perspective view of a hinge cover, a second hinge module, a fourth hinge module, and a case according to some example embodiments;

FIG. 8 is a schematic front perspective view of a portion of the hinge cover, the fourth hinge module, and the case of FIG. 6 according to some example embodiments;

FIGS. 9 and 10 are views of a portion of the hinge cover, the fourth hinge module, and the case of FIG. 6 viewed in a second direction according to some example embodiments;

FIG. 11 is a schematic plan view of a hinge cover, a first hinge module, a third hinge module, a fifth hinge module, and a frame according to some example embodiments;

FIG. 12 is a schematic backside view of a hinge cover, a first hinge module, a third hinge module, a fifth hinge module, and a frame according to some example embodiments;

FIGS. 13 and 14 are cross-sectional views of the frame, the fifth hinge module, and the hinge cover of FIG. 11 taken along line I-I′ according to some example embodiments;

FIGS. 15 and 16 are enlarged cross-sectional views of an example of the region X of FIG. 4 according to some example embodiments;

FIG. 17 is an enlarged cross-sectional view of an example of the region X of FIG. 4 according to some example embodiments;

FIG. 18 is a block diagram of an electronic device according to some example embodiments;

FIG. 19 is a schematic view of electronic devices according to various example embodiments;

FIG. 20 is a view showing a rotational axis of a fourth hinge module according to some example embodiments;

FIG. 21 is a view showing a rotational axis of a fifth hinge module according to some example embodiments; and

FIG. 22 is a graph showing creases of a display according to an inter-axis distance according to some example embodiments.

### DETAILED DESCRIPTION

Reference will now be made in detail to some example embodiments, examples of which are illustrated in the accompanying drawings, wherein like reference numerals refer to like elements throughout. In this regard, the present example embodiments may have different forms and should not be construed as being limited to the descriptions set forth herein. Accordingly, the example embodiments are merely described below, by referring to the figures, to explain some examples of the present inventive concepts. As used herein, the term “and/or” includes any and all combinations of one or more of the associated listed items. Throughout the disclosure, the expression “at least one of a, b, and c” indicates only a, only b, only c, both a and b, both a and c, both b and c, all of a, b, and c, or variations thereof.

As the present inventive concepts allow for various changes and numerous example embodiments, certain example embodiments will be illustrated in the drawings and described in the detailed description. Effects and features of the present inventive concepts, and methods for achieving them will be clarified with reference to example embodiments described below with reference to the drawings. However, the present inventive concepts are not limited to the example embodiments described below and may be implemented in various forms.

Hereinafter, some example embodiments of the present inventive concepts will be described with reference to the accompanying drawings, wherein, like or corresponding elements are given like reference numerals when describing with reference to the drawings, and a repeated description thereof is omitted.

While such terms as “first” and “second” may be used to describe various elements, such elements must not be limited to the above terms. The above terms are used to distinguish one element from another.

The singular forms “a,” “an,” and “the” as used herein are intended to include the plural forms as well unless the context clearly indicates otherwise.

It will be understood that the terms “comprise,” “comprising,” “include” and/or “including” as used herein specify the presence of stated features or components but do not preclude the addition of one or more other features or components.

It will be further understood that, when a layer, region, or element is referred to as being “on” another layer, region, or element, it can be directly or indirectly on the other layer, region, or element. That is, for example, intervening layers, regions, or elements may be present. For example, it will be understood that when an element such as a layer, film, region, or substrate is referred to as being “on” another element, it may be directly on the other element or intervening elements may also be present. In contrast, when an element is referred to as being “directly on” another element, there are no intervening elements present. It will further be understood that when an element is referred to as being “on” another element, it may be above or beneath or adjacent (e.g., horizontally adjacent) to the other elements.

Sizes of elements in the drawings may be exaggerated or reduced for convenience of explanation. As an example, the size and thickness of each element shown in the drawings are arbitrarily represented for convenience of description, and thus, the present inventive concepts are not necessarily limited thereto. It will further be understood that elements and/or properties thereof (e.g., structures, surfaces, directions, or the like), which may be referred to as being “perpendicular,” “parallel,” “coplanar,” or the like with regard to other elements and/or properties thereof (e.g., structures, surfaces, directions, or the like) may be “perpendicular,” “parallel,” “coplanar,” or the like or may be “substantially perpendicular,” “substantially parallel,” “substantially coplanar,” respectively, with regard to the other elements and/or properties thereof. Elements and/or properties thereof (e.g., structures surfaces, directions, or the like) that are “substantially perpendicular” with regard to other elements and/or properties thereof will be understood to be “perpendicular” with regard to the other elements and/or properties thereof within manufacturing tolerances and/or material tolerances and/or have a deviation in magnitude and/or angle from “perpendicular,” or the like with regard to the other elements and/or properties thereof that is equal to or less than 10% (e.g., a tolerance of ±10%).

In an example embodiment below, a first direction DR1, a second direction DR2 and a third direction DR3 are not limited to three axes of the rectangular coordinate system, and may be interpreted in a broader sense including the same. For example, the first direction DR1, the second direction DR2, and the third direction DR3 may be perpendicular to one another, or may represent different orientations that are not perpendicular to one another.

In an example where a certain example embodiment may be implemented differently, a specific process order may be performed in the order different from the described order. As an example, two processes successively described may be simultaneously performed substantially and performed in the opposite order.

Hereinafter, some example embodiments are described in more detail with reference to the accompanying drawings. In the drawings, like reference numerals are used for like elements, and repeated descriptions of like elements are omitted.

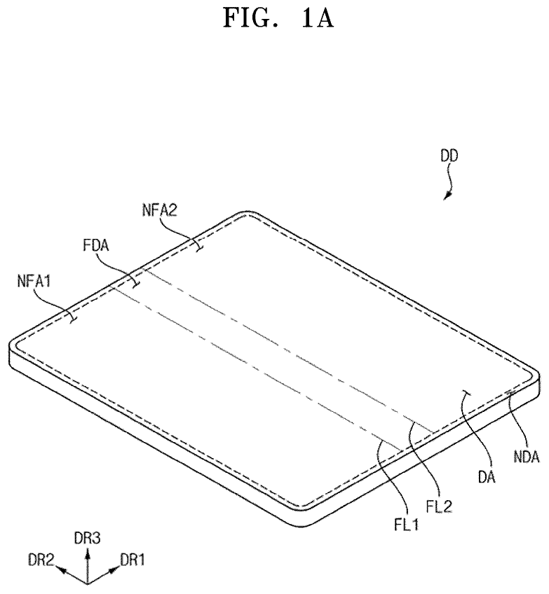

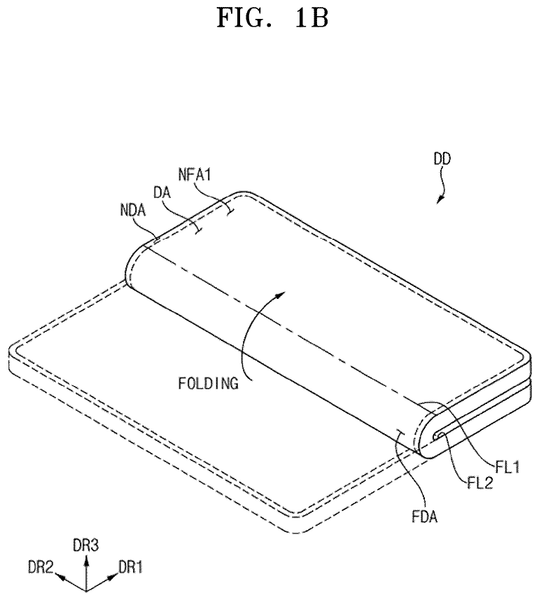

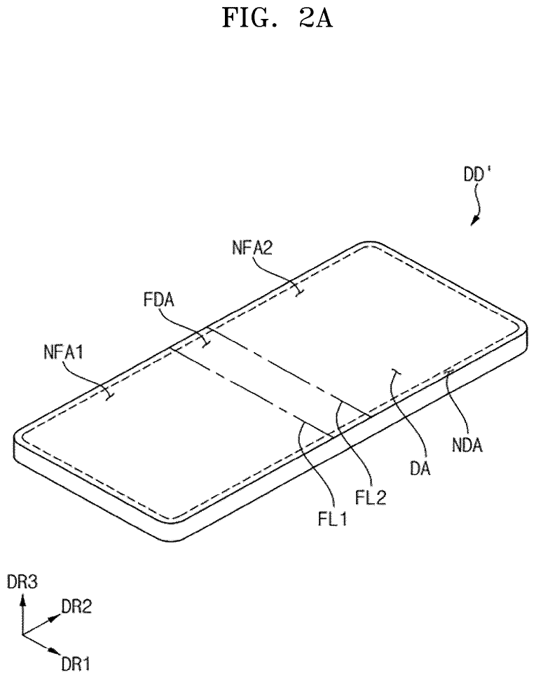

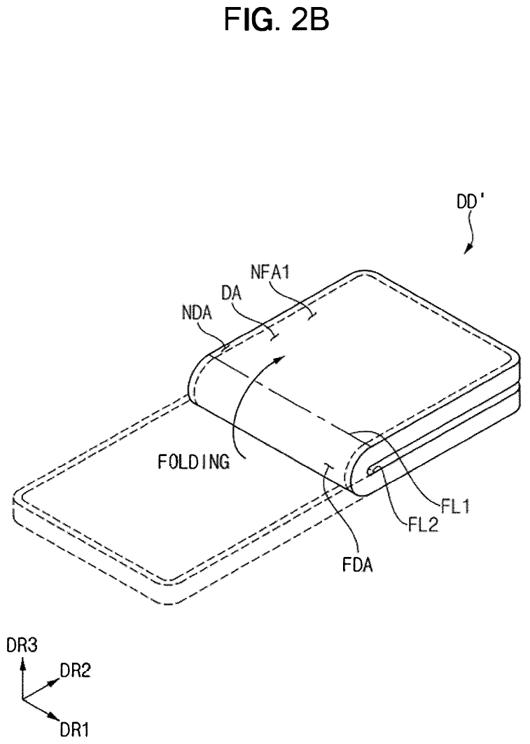

FIG. 1A is a perspective view of a display device in an unfolded state according to some example embodiments. FIG. 1B is a perspective view of the display device of FIG. 1A in a folded state according to some example embodiments. FIG. 2A is a perspective view of a display device in an unfolded state according to some example embodiments. FIG. 2B is a perspective view of the display device of FIG. 2A in a folded state according to some example embodiments.

Referring to FIGS. 1A, 1B, 2A, and 2B, display devices DD and DD′ according to some example embodiments may be activated according to electrical signals. As an example, the display devices DD and DD′ may be small display devices used in small electronic devices such as smartphones, mobile phones, smart watches, game consoles, and/or cameras. However, example embodiments are not limited thereto, and the display devices DD and DD′ according to some example embodiments may be medium-to large-sized display devices used in medium-to large-sized electronic devices such as laptop computers, tablet personal computers (PCs), televisions, computer monitors, vehicle monitors, and/or outdoor billboards.

The display devices DD and DD′ may each include a display area DA and a non-display area NDA. The display area DA may be a region that generates light and/or adjusts a transmittance of light provided from an external light source to display images. As an example, a pixel configured to emit light may be disposed in the display area DA.

The non-display area NDA may be positioned around the display area DA. As an example, the non-display area NDA may surround at least a portion of the display area DA. In some example embodiments, the non-display area NDA may be a region that does not display images. However, example embodiments are not necessarily limited thereto and, in some example embodiments, images may be displayed in at least a portion of the non-display area NDA. As an example, a pixel configured to emit light may be disposed in at least a portion of the non-display area NDA.

The display devices DD and DD′ may be configured to maintain a folded state and an unfolded state. As an example, the display devices DD and DD′ may be folded in an in-folding manner in which the display area DA is disposed in the inside. In an example where the display devices DD and DD′ are folded in the in-folding manner, a portion of the front surface of each of the display devices DD and DD′ may face another portion of the front surface. However, example embodiments are not necessarily limited thereto and, in some example embodiments, the display devices DD and DD′ may be folded in an out-folding manner in which the display area DA is disposed in the outside. In an example where the display devices DD and DD′ are folded in the out-folding manner, a portion of the rear surface of each of the display devices DD and DD′ may face another portion of the rear surface.

In some example embodiments, each of the display devices DD and DD′ may include a folding area FDA, a first non-folding area NFA1, and a second non-folding area NFA2. The folding area FDA may be a region in which the display devices DD and DD′ are bent or folded. The first non-folding area NFA1 and the second non-folding area NFA2 may be regions in which the display devices DD and DD′ are not bent and/or folded. A first folding line FL1 may be a boundary between the folding area FDA and the first non-folding area NFA1. In some example embodiments, a second folding line FL2 may be a boundary between the folding area FDA and the second non-folding area NFA2. As an example, the first folding line FL1 and the second folding line FL2 may be parallel to each other.

The first non-folding area NFA1 may be adjacent to the folding area FDA. The first non-folding area NFA1 may be in contact with one side of the folding area FDA. In some example embodiments, as shown in FIGS. 1A and 1B, the first non-folding area NFA1 may be in contact with the left of the folding area FDA. However, example embodiments are not necessarily limited thereto, and in some example embodiments, as shown in FIGS. 2A and 2B, the first non-folding area NFA1 may be in contact with the lower side of the folding area FDA.

The second non-folding area NFA2 may be adjacent to the folding area FDA. The second non-folding area NFA2 may be in contact with another side of the folding area FDA. In some example embodiments, as shown in FIGS. 1A and 1B, the second non-folding area NFA2 may be in contact with the right of the folding area FDA. However, example embodiments are not necessarily limited thereto, and in some example embodiments, as shown in FIGS. 2A and 2B, the second non-folding area NFA2 may be in contact with the upper side of the folding area FDA.

In some example embodiments, as shown in FIGS. 1A and 1B, each of the first folding line FL1 and the second folding line FL2 may extend in a second direction DR2. In this example, the display device DD may be folded in a first direction DR1. Accordingly, the length of the display device DD in the first direction DR1 may be reduced by approximately half. Accordingly, a user may conveniently carry the display device DD.

In some example embodiments, as shown in FIGS. 2A and 2B, each of the first folding line FL1 and the second folding line FL2 may extend in the first direction DR1. In this example, the display device DD′ may be folded in the second direction DR2. Accordingly, the length of the display device DD′ in the second direction DR2 may be reduced by approximately half. Accordingly, a user may conveniently carry the display device DD′.

Example embodiments described below may be equally applied to the display device DD of FIGS. 1A and 1B and the display device DD′ of FIGS. 2A and 2B. Hereinafter, for convenience of description, some example embodiments are described based on the display device DD of FIGS. 1A and 1B.

In some example embodiments, the first direction DR1 and the second direction DR2 crossing the first direction DR1 may be defined. As an example, the second direction DR2 may be substantially perpendicular to the first direction DR1. However, example embodiments are not limited thereto, and, in some example embodiments, the second direction DR2 may form an acute or obtuse angle with the first direction DR1. In some example embodiments, a third direction DR3 crossing a plane formed by the first direction DR1 and the second direction DR2 may be defined. As an example, the third direction DR3 may be substantially perpendicular to the plane formed by the first direction DR1 and the second direction DR2. However, example embodiments are not limited thereto, and, in some example embodiments, the third direction DR3 may form an acute or obtuse angle with the plane formed by the first direction DR1 and the second direction DR2.

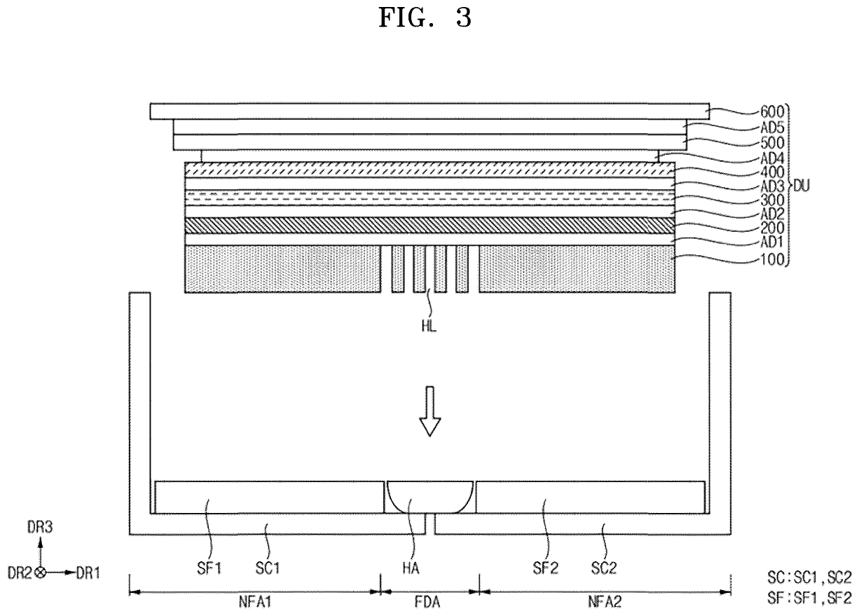

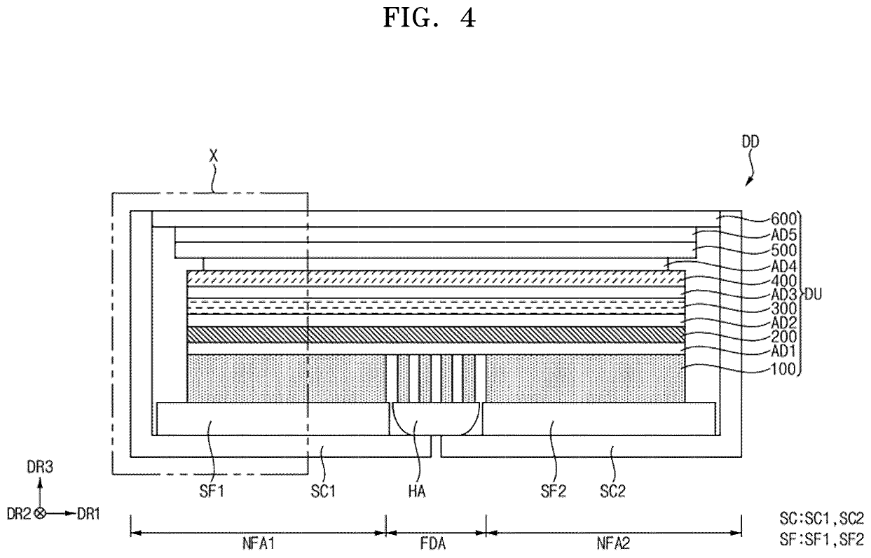

FIGS. 3 and 4 are cross-sectional views of a plurality of elements included in the display device of FIGS. 1A and 1B according to some example embodiments.

Referring to FIGS. 3 and 4, the display device DD according to some example embodiments may include a display unit DU, a frame SF, a case SC, and a hinge assembly HA.

In some example embodiments, the display unit DU may include a metal plate 100, a panel lower member 200, a display panel 300, a polarizing film 400, a cover window 500, a protective film 600, a first adhesive member AD1, a second adhesive member AD2, a third adhesive member AD3, a fourth adhesive member AD4, and a fifth adhesive member AD5.

The metal plate 100 may support the display panel 300. In some example embodiments, the metal plate 100 may include holes HL. The holes HL may be disposed in the folding area FDA. Each of the holes HL may be a portion removed from the upper surface of the metal plate 100 to the lower surface of the metal plate 100. The holes HL may be apart from each other and repeatedly disposed in the first direction DR1. The metal plate 100 may include metal. As an example, the metal plate 100 may include silver (Ag), molybdenum (Mo), aluminum (Al), tungsten (W), copper (Cu), nickel (Ni), chromium (Cr), titanium (Ti), tantalum (Ta), platinum (Pt), and/or scandium (Sc). These materials may be used alone or in combination with each other. However, example embodiments are not necessarily limited thereto and, in some example embodiments, the metal plate 100 may include different kinds of metals.

The panel lower member 200 may be disposed on the metal plate 100. The panel lower member 200 may be configured to alleviate and/or absorb impacts applied to the display panel 300 from the outside of the display panel 300. Accordingly, the panel lower member 200 may be configured to prevent and/or reduce a probability of the display panel 300 from being destroyed. The panel lower member 200 may include a single layer or a plurality of layers. As an example, the panel lower member 200 may include rubber, a urethane-based material, an acryl-based material, and/or foam-molded sponge. These materials may be used alone or in combination with each other. However, example embodiments are not necessarily limited thereto and, in some example embodiments, the panel lower member 200 may include different kinds of materials.

The panel lower member 200 may be attached to the upper surface of the metal plate 100. As an example, the panel lower member 200 may be attached to the upper surface of the metal plate 100 by the first adhesive member AD1. The first adhesive member AD1 may include an optical clear adhesive (OCA), an optical clear resin (OCR), and/or a pressure sensitive adhesive (PSA).

The display panel 300 may be disposed on the panel lower member 200. The display panel 300 may include pixels. Each of the pixels may be configured to emit light. The pixels may be repeatedly disposed in the first direction DR1 and the second direction DR2 in the display panel 300. Because each of the pixels is configured to emit light, the display panel 300 may be configured to display images.

The display panel 300 may be attached to the upper surface of the panel lower member 200. As an example, the display panel 300 may be attached to the upper surface of the panel lower member 200 by the second adhesive member AD2. The second adhesive member AD2 may include an optical clear adhesive (OCA), an optical clear resin (OCR), and/or a pressure sensitive adhesive (PSA).

The polarizing film 400 may be disposed on the display panel 300. Although the polarizing film 400 may include a phase-retarding film such as a linear polarizing plate, a λ/4 plate, and the like, example embodiments are not necessarily limited thereto.

The polarizing film 400 may be attached to the upper surface of the display panel 300. As an example, the polarizing film 400 may be attached to the upper surface of the display panel 300 by the third adhesive member AD3. The third adhesive member AD3 may include an optical clear adhesive (OCA), an optical clear resin (OCR), and/or a pressure sensitive adhesive (PSA).

The cover window 500 may be disposed on the polarizing film 400. As an example, although the cover window 500 may be an ultra-thin glass (UTG) and/or a polyimide film, example embodiments are not necessarily limited thereto.

The cover window 500 may be attached to the upper surface of the polarizing film 400. As an example, the cover window 500 may be attached to the upper surface of the polarizing film 400 by the fourth adhesive member AD4. The fourth adhesive member AD4 may include an optical clear adhesive (OCA), an optical clear resin (OCR), and/or a pressure sensitive adhesive (PSA).

The protective film 600 may be disposed on the cover window 500. As an example, although the protective film 600 may be configured to perform at least one of the functions of anti-scattering, shock absorption, anti-scratch, anti-fingerprint, and/or anti-glare, example embodiments are not necessarily limited thereto.

The protective film 600 may be attached to the upper surface of the cover window 500. As an example, the protective film 600 may be attached to the upper surface of the cover window 500 by the fifth adhesive member AD5. The fifth adhesive member AD5 may include an optical clear adhesive (OCA), an optical clear resin (OCR), and/or a pressure sensitive adhesive (PSA).

Although FIGS. 3 and 4 show an example in which the display unit DU includes the metal plate 100, the panel lower member 200, the display panel 300, the polarizing film 400, the cover window 500, and the protective film 600, example embodiments are not necessarily limited thereto. In some example embodiments, some of the elements of the metal plate 100, the panel lower member 200, the display panel 300, the polarizing film 400, the cover window 500, and the protective film 600 may be omitted, or another element may be added to the display unit DU.

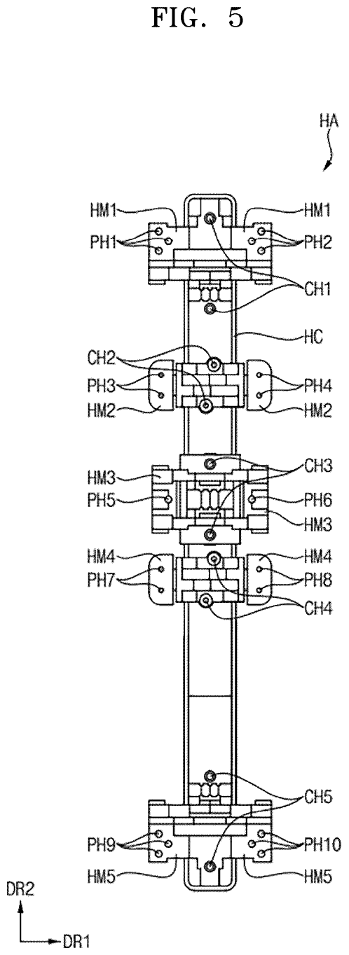

The frame SF may support the display unit DU under the display unit DU. The frame SF may be in contact with the lowermost end of the display unit DU. As an example, as shown in FIG. 4, the frame SF may be in contact with the metal plate 100. In some example embodiments, the frame SF may include a first frame SF1 and a second frame SF2. The first frame SF1 and the second frame SF2 may be apart from each other in a plan view. The first frame SF1 may be disposed on one side of the hinge assembly HA, and the second frame SF2 may be disposed on another side of the hinge assembly HA. As an example, the first frame SF1 may be disposed on one side of the hinge cover (e.g., the hinge cover HC of FIG. 5), and the second frame SF2 may be disposed on another side of the hinge cover (e.g., the hinge cover HC of FIG. 5). As an example, the first frame SF1 may be disposed on the first non-folding area NFA1, and the second frame SF2 may be disposed on the second non-folding area NFA2. However, example embodiments are not necessarily limited thereto and, in some example embodiments, each of the first frame SF1 and the second frame SF2 may be disposed also in a portion of the folding area FDA. The frame SF may include a rigid material. As an example, the frame SF may include silver (Ag), molybdenum (Mo), aluminum (Al), tungsten (W), copper (Cu), nickel (Ni), chromium (Cr), titanium (Ti), tantalum (Ta), platinum (Pt), and/or scandium (Sc). These materials may be used alone or in combination with each other. However, example embodiments are not necessarily limited thereto and, in some example embodiments, the material included in the frame SF may be variously modified according to some example embodiments.

The case SC may accommodate the hinge assembly HA, the display unit DU, and the frame SF. As an example, the case SC may include a bottom portion and a lateral portion, and an accommodation space of the case SC may be defined by the bottom portion and the lateral portion. As an example, the lateral portion may extend in the third direction DR3 from the bottom portion. The hinge assembly HA, the display unit DU, and the frame SF may be accommodated by the accommodation space. As an example, the hinge assembly HA, the display unit DU, and the frame SF may be inserted into the accommodation space. The case SC may be in contact with the uppermost end of the display unit DU. As an example, as shown in FIG. 4, the case SC may be in contact with the protective film 600. As an example, the lateral portion of the case SC may be in contact with the protective film 600. In some example embodiments, the case SC may include a first case SC1 and a second case SC2. The first case SC1 may be disposed on one side of the hinge assembly HA, and the second case SC2 may be disposed on another side of the hinge assembly HA. As an example, the first case SC1 may be disposed on one side of the hinge cover HC, and the second case SC2 may be disposed on another side of the hinge cover HC. As an example, the first case SC1 may be disposed in the first non-folding area NFA1 and the folding area FDA, and the second case SC2 may be disposed in the second non-folding area NFA2 and the folding area FDA. The case SC may include a rigid material. As an example, the case SC may include silver (Ag), molybdenum (Mo), aluminum (Al), tungsten (W), copper (Cu), nickel (Ni), chromium (Cr), titanium (Ti), tantalum (Ta), platinum (Pt), and/or scandium (Sc). These materials may be used alone or in combination with each other. However, example embodiments are not necessarily limited thereto and, in some example embodiments, the material included in the case SC may be variously modified according to some example embodiments.

The hinge assembly HA may be accommodated by the case SC. The hinge assembly HA may be disposed under the display unit DU. The hinge assembly HA may be disposed in the folding area FDA. As shown in FIG. 1B, the display device DD may be folded by a folding operation of the hinge assembly HA. The structure of the hinge assembly HA is described in detail with reference to FIG. 5.

FIG. 5 is a schematic plan view of the hinge assembly HA according to some example embodiments.

Referring to FIG. 5, the hinge assembly HA may include a hinge cover HC, a first hinge module HM1, a second hinge module HM2, a third hinge module HM3, a fourth hinge module HM4, and a fifth hinge module HM5.

The hinge cover HC may be parallel to the first folding line (e.g., the first folding line FL1 in FIG. 1A) and the second folding line (e.g., the second folding line FL2 in FIG. 1A). As an example, the hinge cover HC may extend in the second direction DR2. The hinge cover HC may not rotate during the folding operation and unfolding operation of the hinge assembly HA.

A plurality of hinge modules (HM1, HM2, HM3, HM4, HM5) may sit on the hinge cover HC. As an example, as shown in FIG. 5, each of the first hinge module HM1, the second hinge module HM2, the third hinge module HM3, the fourth hinge module HM4, and the fifth hinge module HM5 may sit on the hinge cover HC. The first hinge module HM1, the second hinge module HM2, the third hinge module HM3, the fourth hinge module HM4, and the fifth hinge module HM5 may be disposed in the opposite direction to the second direction DR2. As an example, the second hinge module HM2 may be apart from the first hinge module HM1 in the opposite direction to the second direction DR2, the third hinge module HM3 may be apart from the second hinge module HM2 in the opposite direction to the second direction DR2, the fourth hinge module HM4 may be apart from the third hinge module HM3 in the opposite direction to the second direction DR2, and the fifth hinge module HM5 may be apart from the fourth hinge module HM4 in the opposite direction to the second direction DR2. As an example, the first hinge module HM1 and the third hinge module HM3 may be apart from each other with the second hinge module HM2 therebetween, and the third hinge module HM3 and the fifth hinge module HM5 may be apart from each other with the fourth hinge module HM4 therebetween.

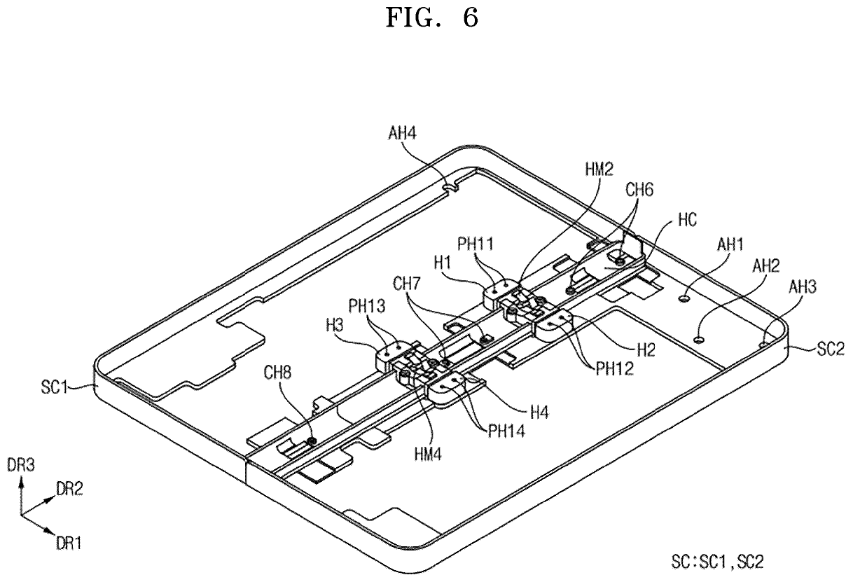

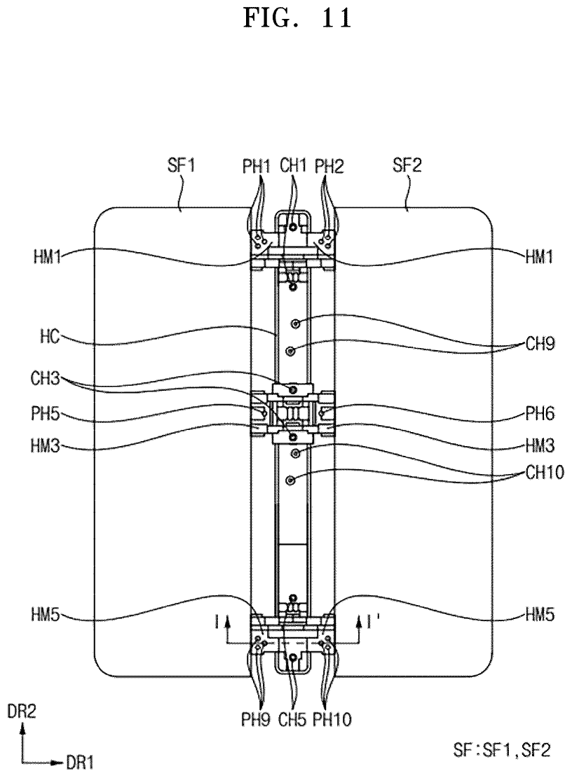

The first hinge module HM1 may include a first fastening hole CH1. The second hinge module HM2 may include a second fastening hole CH2. The third hinge module HM3 may include a third fastening hole CH3. The fourth hinge module HM4 may include a fourth fastening hole CH4. The fifth hinge module HM5 may include a fifth fastening hole CH5. The hinge cover HC may include a sixth fastening hole (e.g., a sixth fastening hole CH6 in FIG. 6), a seventh fastening hole (e.g., a seventh fastening hole CH7 in FIG. 6), an eighth fastening hole (e.g., an eighth fastening hole CH8 in FIG. 6), a ninth fastening hole (e.g., a ninth fastening hole CH9 in FIG. 11), and a tenth fastening hole (e.g., a tenth fastening hole CH10 in FIG. 11).

The first hinge module HM1 may be fixed to the hinge cover HC. As an example, the first hinge module HM1 may be fixed to the hinge cover HC by a coupling member inserted into the first fastening hole CH1 and the sixth fastening hole CH6. For example, the first hinge module HM1 and the hinge cover HC may be coupled to each other by the coupling member inserted into the first fastening hole CH1 and the sixth fastening hole CH6. In some example embodiments, although the coupling member inserted into the first fastening hole CH1 and the sixth fastening hole CH6 may include a screw, a bolt, and/or the like, example embodiments are not necessarily limited thereto.

The second hinge module HM2 may be fixed to the hinge cover HC. As an example, the second hinge module HM2 may be fixed to the hinge cover HC by a coupling member inserted into the second fastening hole CH2 and the ninth fastening hole CH9. For example, the second hinge module HM2 and the hinge cover HC may be coupled to each other by the coupling member inserted into the second fastening hole CH2 and the ninth fastening hole CH9. In some example embodiments, although the coupling member inserted into the second fastening hole CH2 and the ninth fastening hole CH9 may include a screw, a bolt, and/or the like, example embodiments are not necessarily limited thereto.

The third hinge module HM3 may be fixed to the hinge cover HC. As an example, the third hinge module HM3 may be fixed to the hinge cover HC by a coupling member inserted into the third fastening hole CH3 and the seventh fastening hole CH7. For example, the third hinge module HM3 and the hinge cover HC may be coupled to each other by the coupling member inserted into the third fastening hole CH3 and the seventh fastening hole CH7. In some example embodiments, although the coupling member inserted into the third fastening hole CH3 and the seventh fastening hole CH7 may include a screw, a bolt, and/or the like, example embodiments are not necessarily limited thereto.

The fourth hinge module HM4 may be fixed to the hinge cover HC. As an example, the fourth hinge module HM4 may be fixed to the hinge cover HC by a coupling member inserted into the fourth fastening hole CH4 and the tenth fastening hole CH10. For example, the fourth hinge module HM4 and the hinge cover HC may be coupled to each other by the coupling member inserted into the fourth fastening hole CH4 and the tenth fastening hole CH10. In some example embodiments, although the coupling member inserted into the fourth fastening hole CH4 and the tenth fastening hole CH10 may include a screw, a bolt, and/or the like, example embodiments are not necessarily limited thereto.

The fifth hinge module HM5 may be fixed to the hinge cover HC. As an example, the fifth hinge module HM5 may be fixed to the hinge cover HC by a coupling member inserted into the fifth fastening hole CH5 and the eighth fastening hole CH8. For example, the fifth hinge module HM5 and the hinge cover HC may be coupled to each other by the coupling member inserted into the fifth fastening hole CH5 and the eighth fastening hole CH8. In some example embodiments, although the coupling member inserted into the fifth fastening hole CH5 and the eighth fastening hole CH8 may include a screw, a bolt, and/or the like, example embodiments are not necessarily limited thereto.

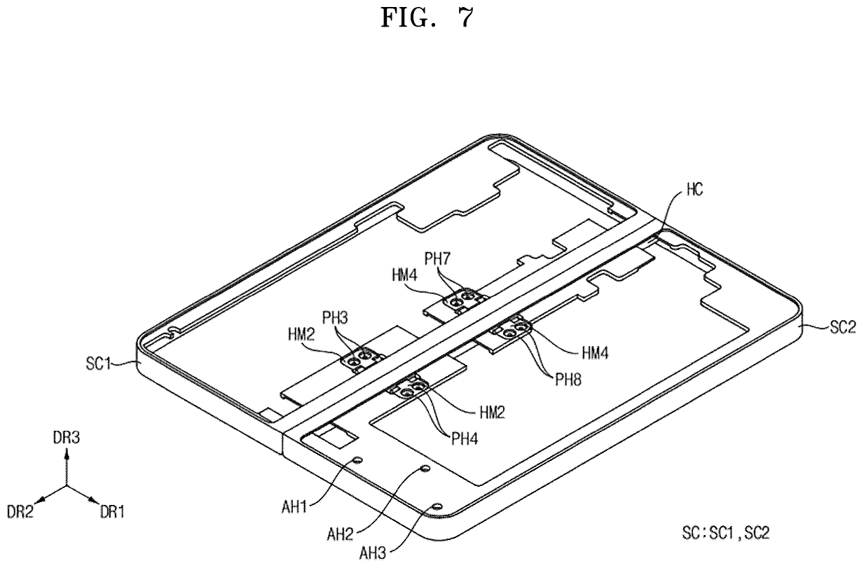

In some example embodiments, the first hinge module HM1 may further include a first through hole PH1 and a second through hole PH2. The second hinge module HM2 may further include a third through hole PH3 and a fourth through hole PH4. The third hinge module HM3 may further include a fifth through hole PH5 and a sixth through hole PH6. The fourth hinge module HM4 may further include a seventh through hole PH7 and an eighth through hole PH8. The fifth hinge module HM5 may further include a ninth through hole PH9 and a tenth through hole PH10. The first through hole PH1, the second through hole PH2, the fifth through hole PH5, the sixth through hole PH6, the ninth through hole PH9, and the tenth through hole PH10 are described below in detail with reference to FIG. 11, and the third through hole PH3, the fourth through hole PH4, the seventh through hole PH7, and the eighth through hole PH8 are described below in detail with reference to FIG. 7.

In some example embodiments, each of the first hinge module HM1, the third hinge module HM3, and the fifth hinge module HM5 may be configured to control the rotation of the frame (e.g., the frame SF in FIG. 4). In some example embodiments, each of the second hinge module HM2 and the fourth hinge module HM4 may be configured to control the rotation of the case (e.g., the case SC in FIG. 4). Hereinafter, the first hinge module HM1, the third hinge module HM3, and the fifth hinge module HM5 configured to control the rotation of the frame are mainly described with reference to FIGS. 6 to 10, and the second hinge module HM2 and the fourth hinge module HM4 configured to control the rotation of the case are mainly described with reference to FIGS. 11 to 14.

FIG. 6 is a schematic front perspective view of the hinge cover HC, the second hinge module HM2, the fourth hinge module HM4, and the case SC according to some example embodiments. FIG. 7 is a schematic rear perspective view of the hinge cover HC, the second hinge module HM2, the fourth hinge module HM4, and the case SC according to some example embodiments.

In FIGS. 6 and 7, the first hinge module HM1, the third hinge module HM3, and the fifth hinge module HM5 of FIG. 5 may be omitted.

Referring to FIGS. 6 and 7, as described above, the case SC may include the first case SC1 and the second case SC2. Each of the second hinge module HM2 and the fourth hinge module HM4 may be configured to control the rotation of the first case SC1 and the rotation of the second case SC2.

In some example embodiments, the case SC may include a first accommodating space H1, a second accommodating space H2, a third accommodating space H3, and a fourth accommodating space H4. As an example, as shown in FIG. 6, the first case SC1 may include the first accommodating space H1 and the third accommodating space H3, and the second case SC2 may include the second accommodating space H2 and the fourth accommodating space H4. Each of the first accommodating space H1, the second accommodating space H2, the third accommodating space H3, and the fourth accommodating space H4 may be a space defined by a lateral wall and an upper surface.

In some example embodiments, the case SC may further include an eleventh through hole PH11, a twelfth through hole PH12, a thirteenth through hole PH13, and a fourteenth through hole PH14. As an example, as shown in FIG. 6, the first case SC1 may include the eleventh through hole PH11 and the thirteenth through hole PH13, and the second case SC2 may include the twelfth through hole PH12 and the fourteenth through hole PH14. As an example, the eleventh through hole PH11 may be included in the upper surface defining the first accommodating space H1, the twelfth through hole PH12 may be included in the upper surface defining the second accommodating space H2, the thirteenth through hole PH13 may be included in the upper surface defining the third accommodating space H3, and the fourteenth through hole PH14 may be included in the upper surface defining the fourth accommodating space H4.

The first accommodating space H1 may be configured to accommodate a portion of the second hinge module HM2. In the first accommodating space H1, the second hinge module HM2 may be fixed to the first case SC1. As an example, the second hinge module HM2 may be fixed to the first case SC1 by a coupling member inserted into the third through hole PH3 and the eleventh through hole PH11. For example, the second hinge module HM2 and the first case SC1 may be coupled to each other by the coupling member inserted into the third through hole PH3 and the eleventh through hole PH11. As an example, although the coupling member inserted into the third through hole PH3 and the eleventh through hole PH11 may include a screw, a bolt, and/or the like, example embodiments are not necessarily limited thereto.

The second accommodating space H2 may be configured to accommodate a portion of the second hinge module HM2. In the second accommodating space H2, the second hinge module HM2 may be fixed to the second case SC2. As an example, the second hinge module HM2 may be fixed to the second case SC2 by a coupling member inserted into the fourth through hole PH4 and the twelfth through hole PH12. For example, the second hinge module HM2 and the second case SC2 may be coupled to each other by the coupling member inserted into the fourth through hole PH4 and the twelfth through hole PH12. As an example, although the coupling member inserted into the fourth through hole PH4 and the twelfth through hole PH12 may include a screw, a bolt, and/or the like, example embodiments are not necessarily limited thereto.

The third accommodating space H3 may be configured to accommodate a portion of the fourth hinge module HM4. In the third accommodating space H3, the fourth hinge module HM4 may be fixed to the first case SC1. As an example, the fourth hinge module HM4 may be fixed to the first case SC1 by a coupling member inserted into the seventh through hole PH7 and the thirteenth through hole PH13. For example, the fourth hinge module HM4 and the first case SC1 may be coupled to each other by the coupling member inserted into the seventh through hole PH7 and the thirteenth through hole PH13. As an example, although the coupling member inserted into the seventh through hole PH7 and the thirteenth through hole PH13 may include a screw, a bolt, and/or the like, example embodiments are not necessarily limited thereto.

The fourth accommodating space H4 may be configured to accommodate a portion of the fourth hinge module HM4. In the fourth accommodating space H4, the fourth hinge module HM4 may be fixed to the second case SC2. As an example, the fourth hinge module HM4 may be fixed to the second case SC2 by a coupling member inserted into the eighth through hole PH8 and the fourteenth through hole PH14. For example, the fourth hinge module HM4 and the second case SC2 may be coupled to each other by the coupling member inserted into the eighth through hole PH8 and the fourteenth through hole PH14. As an example, although the coupling member inserted into the eighth through hole PH8 and the fourteenth through hole PH14 may include a screw, a bolt, and/or the like, example embodiments are not necessarily limited thereto.

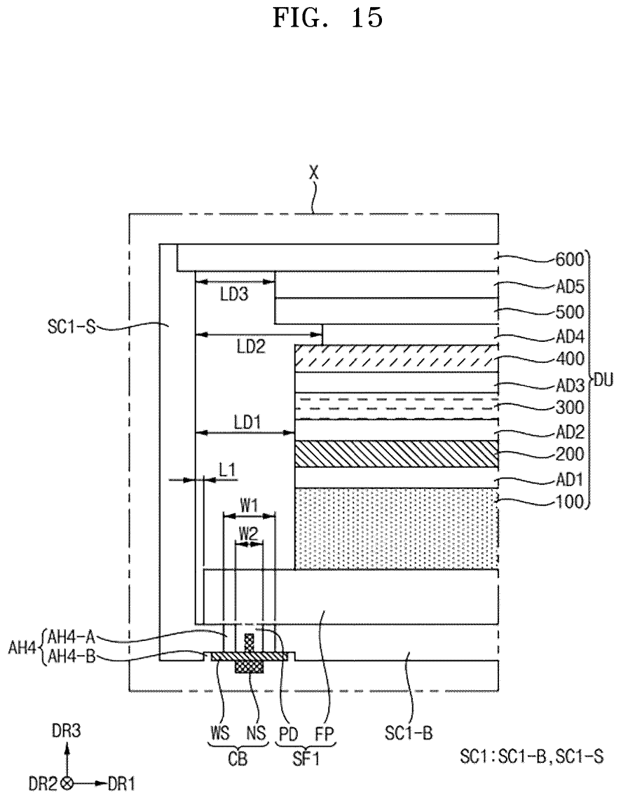

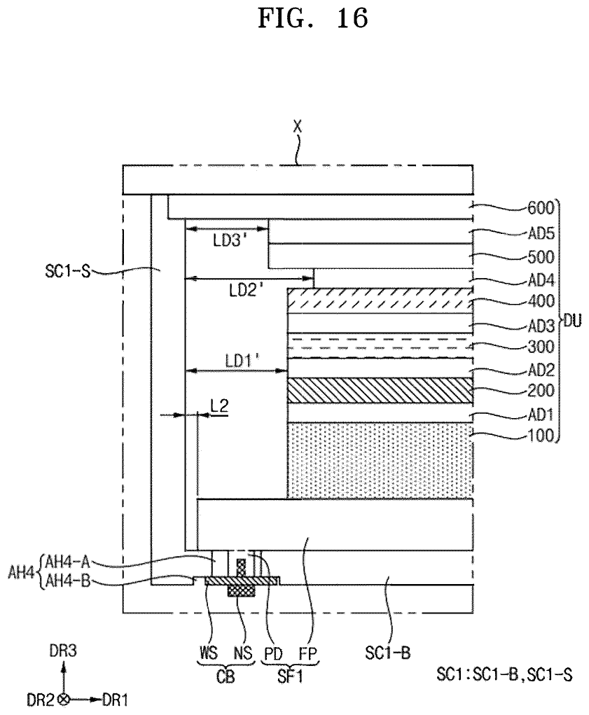

In some example embodiments, the case SC may further include coupling holes. As an example, as shown in FIGS. 6 and 7, the case SC may further include a first coupling hole AH1, a second coupling hole AH2, and a third coupling hole AH3. Each of the first coupling hole AH1, the second coupling hole AH2, the third coupling hole AH3 may be configured to accommodate at least a portion of the frame (e.g., the frame SF in FIG. 4). The structure of the first coupling hole AH1, the second coupling hole AH2, the third coupling hole AH3 is described in detail with reference to FIGS. 15 and 16.

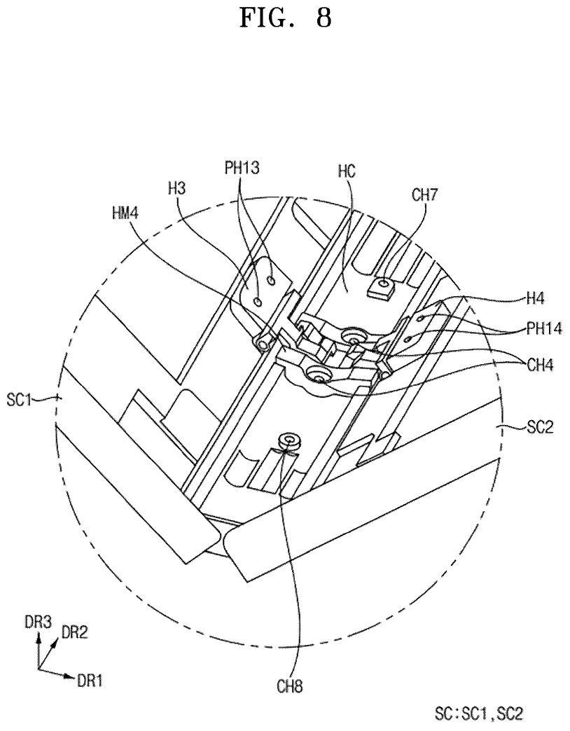

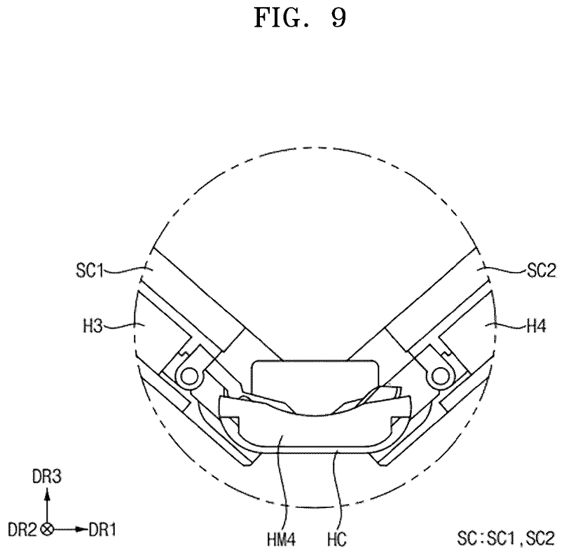

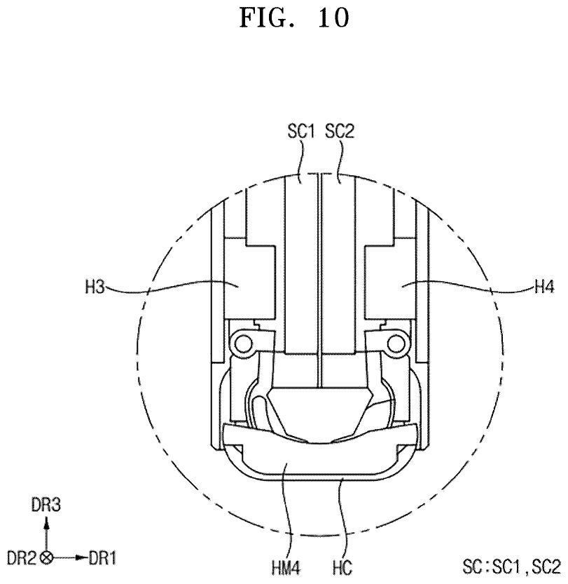

FIG. 8 is a schematic front perspective view of a portion of the hinge cover HC, the fourth hinge module HM4, and the case SC of FIG. 6 according to some example embodiments. FIGS. 9 and 10 are views of the hinge cover HC, the fourth hinge module HM4, and the case SC of FIG. 6 viewed in the second direction DR2 according to some example embodiments.

According to some example embodiments, FIGS. 8 and 9 may show a state in which folding of the display device (e.g., the display device DD of FIG. 4) is performed according to a folding operation of the hinge assembly (e.g., the hinge assembly HA in FIG. 5), and FIG. 10 may show a state in which folding of the display device is completed.

Referring to FIGS. 8, 9, and 10, as described above, the second hinge module (e.g., the second hinge module HM2 in FIG. 6) and the fourth hinge module HM4 may be configured to control the rotation of the case SC. As an example, each of the second hinge module HM2 and the fourth hinge module HM4 may be configured to control the rotation of the first case SC1 and the second case SC2. As an example, in an example where folding of the display device (e.g., the display device DD of FIG. 4) is performed according to a folding operation of the hinge assembly (e.g., the hinge assembly HA in FIG. 5), each of the second hinge module HM2 and the fourth hinge module HM4 may be configured to control the rotation of the first case SC1 and the second case SC2.

In some example embodiments, the fourth hinge module HM4 may include a first portion fixed to the hinge cover HC, a second portion accommodated in the third accommodating space H3, and a third portion accommodated in the fourth accommodating space H4. The first portion may include the fourth fastening hole CH4. In an example where the folding of the display device is performed according to the folding operation of the hinge assembly, the second portion and the third portion may be configured to rotate. As an example, each of the second portion and the third portion may be configured to rotate about the second direction DR2 as a rotational axis. As the second portion rotates about the second direction DR2 as a rotational axis, the first case SC1 may rotate about the second direction DR2 as a rotational axis. As the third portion rotates about the second direction DR2 as a rotational axis, the second case SC2 may rotate about the second direction DR2 as a rotational axis. The second hinge module HM2 and the fourth hinge module HM4 may have substantially the same structure.

As shown in FIG. 10, when the folding of the display device is completed, the first case SC1 and the second case SC2 may face each other.

In some example embodiments, in an example where the unfolding of the display device DD is performed according to the unfolding operation of the hinge assembly, each of the second hinge module HM2 and the fourth hinge module HM4 may be configured to control the rotation of the first case SC1 and the second case SC2.

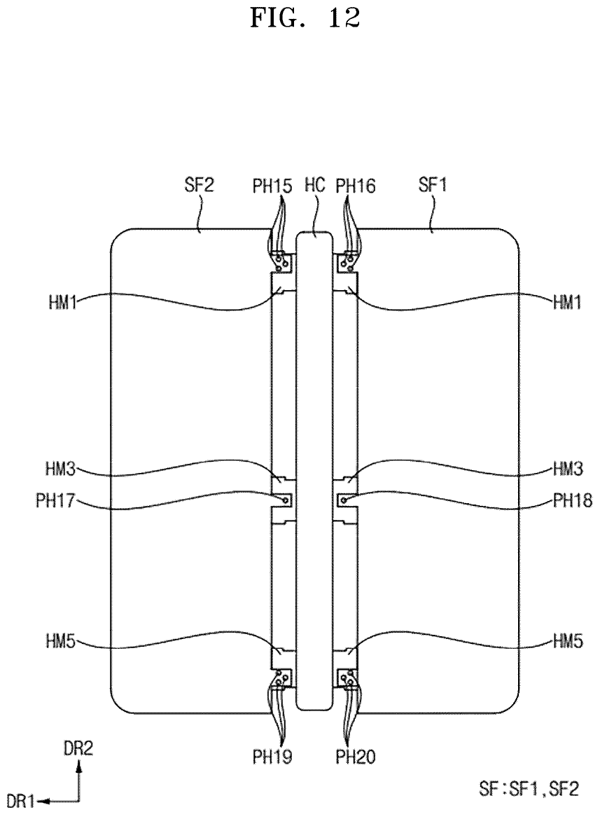

FIG. 11 is a schematic plan view of the hinge cover HC, the first hinge module HM1, the third hinge module HM3, the fifth hinge module HM5, and the frame SF according to some example embodiments. FIG. 12 is a schematic backside view of the hinge cover HC, the first hinge module HM1, the third hinge module HM3, the fifth hinge module HM5, and the frame SF according to some example embodiments.

In FIGS. 11 and 12, the second hinge module HM2 and the fourth hinge module HM4 of FIG. 5 may be omitted.

Referring to FIGS. 11 and 12, as described above, the frame SF may include the first frame SF1 and the second frame SF2. Each of the first hinge module HM1, the third hinge module HM3, the fifth hinge module HM5 may be configured to control the rotation of the first frame SF1 and the second frame SF2.

In some example embodiments, the frame SF may include a fifteenth through hole PH15, a sixteenth through hole PH16, a seventeenth through hole PH17, an eighteenth through hole PH18, a nineteenth through hole PH19, and a twentieth through hole PH20. As an example, as shown in FIG. 12, the first frame SF1 may include the sixteenth through hole PH16, the eighteenth through hole PH18, and the twentieth through hole PH20, and the second frame SF2 may include the fifteenth through hole PH15, the seventeenth through hole PH17, and the nineteenth through hole PH19.

The first hinge module HM1 may be fixed to the first frame SF1. As an example, the first hinge module HM1 may be fixed to the first frame SF1 by a coupling member inserted into the first through hole PH1 and the sixteenth through hole PH16. For example, the first hinge module HM1 and the first frame SF1 may be coupled to each other by the coupling member inserted into the first through hole PH1 and the sixteenth through hole PH16. As an example, although the coupling member inserted into the first through hole PH1 and the sixteenth through hole PH16 may include a screw, a bolt, and/or the like, example embodiments are not necessarily limited thereto.

The first hinge module HM1 may be fixed to the second frame SF2. As an example, the first hinge module HM1 may be fixed to the second frame SF2 by a coupling member inserted into the second through hole PH2 and the fifteenth through hole PH15. For example, the first hinge module HM1 and the second frame SF2 may be coupled to each other by the coupling member inserted into the second through hole PH2 and the fifteenth through hole PH15. As an example, although the coupling member inserted into the second through hole PH2 and the fifteenth through hole PH15 may include a screw, a bolt, and/or the like, example embodiments are not necessarily limited thereto.

The third hinge module HM3 may be fixed to the first frame SF1. As an example, the third hinge module HM3 may be fixed to the first frame SF1 by a coupling member inserted into the fifth through hole PH5 and the eighteenth through hole PH18. For example, the third hinge module HM3 and the first frame SF1 may be coupled to each other by the coupling member inserted into the fifth through hole PH5 and the eighteenth through hole PH18. As an example, although the coupling member inserted into the fifth through hole PH5 and the eighteenth through hole PH18 may include a screw, a bolt, and/or the like, example embodiments are not necessarily limited thereto.

The third hinge module HM3 may be fixed to the second frame SF2. As an example, the third hinge module HM3 may be fixed to the second frame SF2 by a coupling member inserted into the sixth through hole PH6 and the seventeenth through hole PH17. For example, the third hinge module HM3 and the second frame SF2 may be coupled to each other by the coupling member inserted into the sixth through hole PH6 and the seventeenth through hole PH17. As an example, although the coupling member inserted into the sixth through hole PH6 and the seventeenth through hole PH17 may include a screw, a bolt, and/or the like, example embodiments are not necessarily limited thereto.

The fifth hinge module HM5 may be fixed to the first frame SF1. As an example, the fifth hinge module HM5 may be fixed to the first frame SF1 by a coupling member inserted into the ninth through hole PH9 and the twentieth through hole PH20. For example, the fifth hinge module HM5 and the first frame SF1 may be coupled to each other by the coupling member inserted into the ninth through hole PH9 and the twentieth through hole PH20. As an example, although the coupling member inserted into the ninth through hole PH9 and the twentieth through hole PH20 may include a screw, a bolt, and/or the like, example embodiments are not necessarily limited thereto.

The fifth hinge module HM5 may be fixed to the second frame SF2. As an example, the fifth hinge module HM5 may be fixed to the second frame SF2 by a coupling member inserted into the tenth through hole PH10 and the nineteenth through hole PH19. for example, the fifth hinge module HM5 and the second frame SF2 may be coupled to each other by the coupling member inserted into the tenth through hole PH10 and the nineteenth through hole PH19. As an example, although the coupling member inserted into the tenth through hole PH10 and the nineteenth through hole PH19 may include a screw, a bolt, and/or the like, example embodiments are not necessarily limited thereto.

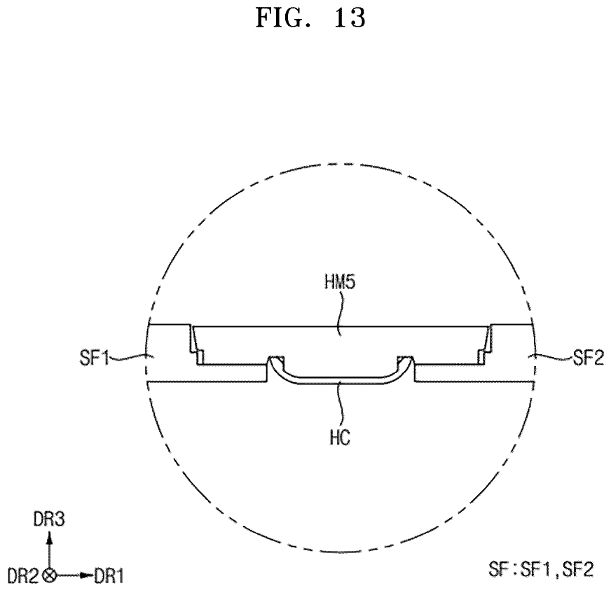

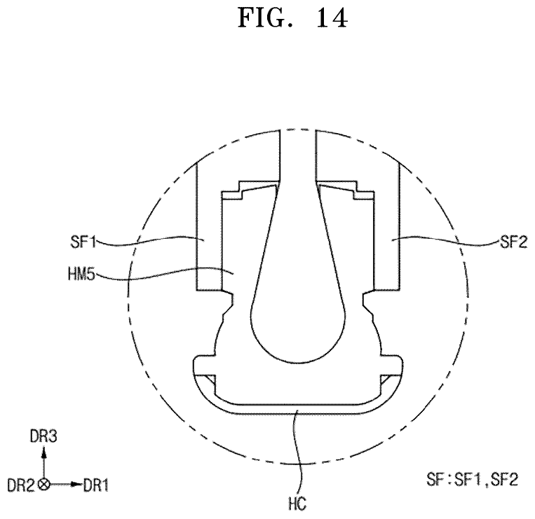

FIGS. 13 and 14 are cross-sectional views of the frame SF, the fifth hinge module HM5, and the hinge cover HC of FIG. 11, taken along line I-I′ according to some example embodiments.

According to some example embodiments, FIG. 13 may show a state in which the display device (e.g., the display device DD in FIG. 4) is unfolded, and FIG. 14 may show a state in which the display device is folded.

Referring to FIGS. 13 and 14, as described above, each of the first hinge module (e.g., the first hinge module HM1 in FIG. 5), the third hinge module (e.g., the third hinge module HM3 in FIG. 5), and the fifth hinge module HM5 may be configured to control the rotation of the frame SF. As an example, each of the first hinge module HM1, the third hinge module HM3, the fifth hinge module HM5 may be configured to control the rotation of the first frame SF1 and the second frame SF2. As an example, in an example where folding of the display device (e.g., the display device DD of FIG. 4) is performed according to a folding operation of the hinge assembly (e.g., the hinge assembly HA in FIG. 5), each of the first hinge module HM1, the third hinge module HM3, and the fifth hinge module HM5 may be configured to control the rotation of the first frame SF1 and the second frame SF2.

In some example embodiments, the fifth hinge module HM5 may include a first portion fixed to the hinge cover HC, a second portion fixed to the first frame SF1, and a third portion fixed to the second frame SF2. The second portion may include the ninth through hole (e.g., the ninth through hole PH9 in FIG. 11), and the third portion may include the tenth through hole (e.g., the tenth through hole PH10 in FIG. 11). In an example where the folding of the display device is performed according to the folding operation of the hinge assembly, the second portion and the third portion may be configured to rotate. As an example, each of the second portion and the third portion may be configured to rotate about the second direction DR2 as a rotational axis. As the second portion rotates about the second direction DR2 as a rotation axis, the first frame SF1 may rotate about the second direction DR2 as a rotational axis. As the third portion rotates about the second direction DR2 as a rotational axis, the second frame SF2 may rotate about the second direction DR2 as a rotational axis. The first hinge module HM1, the third hinge module HM3, and the fifth hinge module HM5 may have substantially the same structure.

As shown in FIG. 14, when the folding of the display device is completed, the first frame SF1 and the second frame SF2 may face each other.

In some example embodiments, in an example where the unfolding of the display device is performed according to the unfolding operation of the hinge assembly, each of the first hinge module HM1, the third hinge module HM3, and the fifth hinge module HM5 may be configured to control the rotation of the first frame SF1 and the second frame SF2.

FIGS. 15 and 16 are enlarged cross-sectional views of an example of the region X of FIG. 4 according to some example embodiments.

According to some example embodiments, FIG. 15 may show a state in which the display device (e.g., the display device DD in FIG. 4) is unfolded, and FIG. 16 may show a state in which the display device is folded.

Referring to FIG. 15, the case (e.g., the case SC in FIG. 4) may include a bottom portion and a lateral portion. As an example, as shown in FIG. 15, the first case SC1 may include a bottom portion SC1-B and a lateral portion SC1-S. The lateral portion SC1-S may extend from the bottom portion SC1-B. As an example, the lateral portion SC1-S may extend from the bottom portion SC1-B in the third direction DR3. The lateral portion SC1-S may be joined to the bottom portion SC1-B. At this time, the bottom portion SC1-B may shield one end of a fourth coupling hole AH4.

As described above, the case (e.g., the case SC in FIG. 4) may include the first coupling hole (e.g., the first coupling hole AH1 in FIG. 6), the second coupling hole (e.g., the second coupling hole AH2 in FIG. 6), the third coupling hole (e.g., the third coupling hole AH3 in FIG. 6), and the fourth coupling hole AH4. As an example, as shown in FIG. 15, the first case SC1 may include the fourth coupling hole AH4. As an example, the lateral portion SC1-S may include the fourth coupling hole AH4. The fourth coupling hole AH4 may include a first portion AH4-A and a second portion AH4-B. The second portion AH4-B may be disposed under the first portion AH4-A. In some example embodiments, the width of the second portion AH4-B in the first direction DR1 may be greater than a width W1 of the first portion AH4-A in the first direction DR1. However, example embodiments are not necessarily limited thereto and, in some example embodiments, the fourth coupling hole AH4 may include only the first portion AH4-A. The first coupling hole AH1, the second coupling hole AH2, the third coupling hole AH3, and the fourth coupling hole AH4 may have substantially the same structure.

In some example embodiments, the fourth coupling hole AH4 may accommodate at least a portion of the frame (e.g., the frame SF in FIG. 4). As an example, as shown in FIG. 15, the fourth coupling hole AH4 may accommodate at least a portion of the first frame SF1. In this example, the first frame SF1 may include a flat portion FP and a protruding portion PD protruding from the flat portion FP, wherein the flat portion FP is in contact with the display unit DU. The protruding portion PD may be accommodated by the fourth coupling hole AH4.

In some example embodiments, the frame may be fixed to the case. As an example, as shown in FIG. 15, the first frame SF1 may be fixed to the first case SC1 within the fourth coupling hole AH4. As an example, the first frame SF1 may be fixed to the first case SC1 through a coupling member CB within the fourth coupling hole AH4. In some example embodiments, the coupling member CB may include a first coupling member NS and a second coupling member WS. Although the first coupling member NS may be a screw and bolt, example embodiments are not necessarily limited thereto. In some example embodiments, the second coupling member WS may be a washer.

Referring to FIGS. 5, 15, and 16, as described above, the frame may be in contact with the lowermost end of the display unit DU. The lowermost end of the display unit DU may be an element disposed at the lowermost portion among the elements included in the display unit DU. As an example, as shown in FIG. 15, the lowermost end of the display unit DU may be the metal plate 100. However, example embodiments are not necessarily limited thereto and in an example where the display unit DU further includes another element disposed under the metal plate 100, the lowermost end of the display unit DU may be the other element disposed under the metal plate 100. In some example embodiments, as described above, each of the first hinge module HM1, the third hinge module HM3, and the fifth hinge module HM5 may be configured to control the rotation of the frame (e.g., the frame SF in FIG. 4). Accordingly, each of the first hinge module HM1, the third hinge module HM3, and the fifth hinge module HM5 may be configured to control the rotation of the lowermost end of the display unit DU in contact with the frame. As an example, each of the first hinge module HM1, the third hinge module HM3, and the fifth hinge module HM5 may be configured to control the rotation of the metal plate 100 in contact with the frame.

In some example embodiments, the case may be in contact with the uppermost end of the display unit DU. As an example, as shown in FIG. 15, the lateral portion SC1-S of the first case SC1 may be in contact with the uppermost end of the display unit DU. As an example, the uppermost end of the display unit DU may be fixed to the lateral portion SC1-S. As an example, the uppermost end of the display unit DU may be fixed to the lateral portion SC1-S through an OCA, an OCR, and/or PSA. The uppermost end of the display unit DU may be an element disposed at the uppermost portion among the elements included in the display unit DU. As an example, as shown in FIG. 15, the uppermost end of the display unit DU may be a protective film 600. However, example embodiments are not necessarily limited thereto and in an example where the display unit DU further includes another element disposed on the protective film 600, the uppermost end of the display unit DU may be the other element disposed on the protective film 600. In some example embodiments, as described above, each of the second hinge module HM2 and the fourth hinge module HM4 may be configured to control the rotation of the case (e.g., the case SC in FIG. 4). Accordingly, each of the second hinge module HM2 and the fourth hinge module HM4 may be configured to control the rotation of the uppermost end of the display unit DU in contact with the case. As an example, each of the second hinge module HM2 and the fourth hinge module HM4 may be configured to control the rotation of the protective film 600 in contact with the case.

In an example where the folding of the display device is performed according to the folding operation of the hinge assembly, the second hinge module HM2 and the fourth hinge module HM4 configured to control the rotation of the uppermost end of the display unit DU may rotate about a first axis as a rotational axis, and the first hinge module HM1, the third hinge module HM3, and the fifth hinge module HM5 configured to control the rotation of the lowermost end of the display unit DU may rotate about a second axis as a rotational axis. Each of the first axis and the second axis may extend in the second direction DR2. In some example embodiments, the position of the first axis and the position of the second axis may be different from each other in a plan view. Accordingly, the rotation of the uppermost end of the display unit DU and the rotation of the lowermost end of the display unit DU may be controlled independently of each other. As an example, the rotation of the protective film 600 and the rotation of the metal plate 100 may be controlled independently of each other.

According to some example embodiments, because the position of the first axis and the position of the second axis are different from each other in a plan view, the rotation of the uppermost end of the display unit DU and the rotation of the lowermost end of the display unit DU are controlled independently of each other, and the uppermost end of the display unit DU is fixed to the lateral portion SC1-S, when the folding of the display device is performed, elements of the display unit DU other than the uppermost end of the display unit DU may slip toward the folding area (e.g., the folding area FDA in FIG. 4).

As an example, as shown in FIG. 16, when the folding of the display device is performed, each of the metal plate 100, the panel lower member 200, the display panel 300, the polarizing film 400, the cover window 500, the first adhesive member AD1, the second adhesive member AD2, the third adhesive member AD3, the fourth adhesive member AD4, and the fifth adhesive member AD5 may slip in the first direction DR1. Although the degree to which the first adhesive member AD1, the second adhesive member AD2, the third adhesive member AD3, the fourth adhesive member AD4, and the fifth adhesive member AD5 slip may be greater than the degree to which the metal plate 100, the panel lower member 200, the display panel 300, the polarizing film 400, and the cover window 500 slip, example embodiments are not necessarily limited thereto.

Accordingly, a planar separation distance between the metal plate 100 and the lateral portion SC1-S may increase. As an example, in the case where the display device of FIG. 16 is folded, a planar separation distance LD1′ between one end of the metal plate 100 and the lateral portion SC1-S may be greater than a planar separation distance LD1 (e.g., illustrated in FIG. 15) between one end of the metal plate 100 and the lateral portion SC1-S in the case where the display device of FIG. 15 is unfolded.

Accordingly, a planar separation distance between the panel lower member 200 and the lateral portion SC1-S may increase. As an example, in the case where the display device of FIG. 16 is folded, a planar separation distance LD1′ between one end of the panel lower member 200 and the lateral portion SC1-S may be greater than a planar separation distance LD1 between one end of the panel lower member 200 and the lateral portion SC1-S in the case where the display device of FIG. 15 is unfolded.

In some example embodiments, a planar separation distance between the display panel 300 and the lateral portion SC1-S may increase. As an example, in the case where the display device of FIG. 16 is folded, a planar separation distance LD1′ between one end of the display panel 300 and the lateral portion SC1-S may be greater than a planar separation distance LD1 between one end of the display panel 300 and the lateral portion SC1-S in the case where the display device of FIG. 15 is unfolded.

In some example embodiments, a planar separation distance between the polarizing film 400 and the lateral portion SC1-S may increase. As an example, in the case where the display device of FIG. 16 is folded, a planar separation distance LD1′ between one end of the polarizing film 400 and the lateral portion SC1-S may be greater than a planar separation distance LD1 between one end of the polarizing film 400 and the lateral portion SC1-S in the case where the display device of FIG. 15 is unfolded.

In some example embodiments, a planar separation distance between the cover window 500 and the lateral portion SC1-S may increase. As an example, in the case where the display device of FIG. 16 is folded, a planar separation distance LD3′ between one end of the cover window 500 and the lateral portion SC1-S may be greater than a planar separation distance LD3 between one end of the cover window 500 and the lateral portion SC1-S in the case where the display device of FIG. 15 is unfolded.

Accordingly, a planar separation distance between the first adhesive member AD1 and the lateral portion SC1-S may increase. As an example, in the case where the display device of FIG. 16 is folded, a planar separation distance LD1′ between one end of the first adhesive member AD1 and the lateral portion SC1-S may be greater than a planar separation distance LD1 between one end of the first adhesive member AD1 and the lateral portion SC1-S in the case where the display device of FIG. 15 is unfolded.

Accordingly, a planar separation distance between the second adhesive member AD2 and the lateral portion SC1-S may increase. As an example, in the case where the display device of FIG. 16 is folded, a planar separation distance LD1′ between one end of the second adhesive member AD2 and the lateral portion SC1-S may be greater than a planar separation distance LD1 between one end of the second adhesive member AD2 and the lateral portion SC1-S in the case where the display device of FIG. 15 is unfolded.

Accordingly, a planar separation distance between the third adhesive member AD3 and the lateral portion SC1-S may increase. As an example, in the case where the display device of FIG. 16 is folded, a planar separation distance LD1′ between one end of the third adhesive member AD3 and the lateral portion SC1-S may be greater than a planar separation distance LD1 between one end of the third adhesive member AD3 and the lateral portion SC1-S in the case where the display device of FIG. 15 is unfolded.

Accordingly, a planar separation distance between the fourth adhesive member AD4 and the lateral portion SC1-S may increase. As an example, in the case where the display device of FIG. 16 is folded, a planar separation distance LD2′ between one end of the fourth adhesive member AD4 and the lateral portion SC1-S may be greater than a planar separation distance LD2 between one end of the fourth adhesive member AD4 and the lateral portion SC1-S in the case where the display device of FIG. 15 is unfolded.

Accordingly, a planar separation distance between the fifth adhesive member AD5 and the lateral portion SC1-S may increase. As an example, in the case where the display device of FIG. 16 is folded, a planar separation distance LD3′ between one end of the fifth adhesive member AD5 and the lateral portion SC1-S may be greater than a planar separation distance LD3 between one end of the fifth adhesive member AD5 and the lateral portion SC1-S in the case where the display device of FIG. 15 is unfolded.

In some example embodiments, in the case where the folding of the display device is performed according to the folding operation of the hinge assembly, the frame may slip toward the folding area. As an example, as shown in FIG. 15, in the case where the folding of the display device is performed, the first frame SF1 may slip in the first direction DR1. Accordingly, a planar separation distance between the first frame SF1 and the lateral portion SC1-S may increase. As an example, in the case where the display device of FIG. 16 is folded, a planar separation distance L2 between one end of the first frame SF1 and the lateral portion SC1-S may be greater than a planar separation distance L1 between one end of the first frame SF1 and the lateral portion SC1-S in the case where the display device of FIG. 15 is unfolded.

When the folding of the display device is performed, in the example where each of the first frame SF1, the metal plate 100, the panel lower member 200, the display panel 300, the polarizing film 400, the cover window 500, the first adhesive member AD1, the second adhesive member AD2, the third adhesive member AD3, the fourth adhesive member AD4, and the fifth adhesive member AD5 slips in a direction away from the folding area, a considerable space for accommodating (or alternatively, advantageous to accommodate) each of the first frame SF1, the metal plate 100, the panel lower member 200, the display panel 300, the polarizing film 400, the cover window 500, the first adhesive member AD1, the second adhesive member AD2, the third adhesive member AD3, the fourth adhesive member AD4, and the fifth adhesive member AD5 may be required. As an example, when the folding of the display device is performed, considerable spaces may be required or alternatively, advantageous between the lateral portion SC1-S and the first frame SF1, between the lateral portion SC1-S and the metal plate 100, between the lateral portion SC1-S and the panel lower member 200, between the lateral portion SC1-S and the display panel 300, between the lateral portion SC1-S and the polarizing film 400, between the lateral portion SC1-S and the cover window 500, between the lateral portion SC1-S and the first adhesive member AD1, between the lateral portion SC1-S and the second adhesive member AD2, between the lateral portion SC1-S and the third adhesive member AD3, between the lateral portion SC1-S and the fourth adhesive member AD4, and between the lateral portion SC1-S and the fifth adhesive member AD5, such that each of the first frame SF1, the first metal plate 100, the panel lower member 200, the display panel 300, the polarizing film 400, the cover window 500, the first adhesive member AD1, the second adhesive member AD2, the third adhesive member AD3, the fourth adhesive member AD4, and the fifth adhesive member AD5 is not in contact with the lateral portion SC1-S. In this example, a structure and the like may be required or alternatively, advantageous to prevent and/or reduce the considerable spaces from being perceived by users.

Unlike this, according to some example embodiments, each of the first frame SF1, the metal plate 100, the panel lower member 200, the display panel 300, the polarizing film 400, the cover window 500, the first adhesive member AD1, the second adhesive member AD2, the third adhesive member AD3, the fourth adhesive member AD4, and the fifth adhesive member AD5 may slip toward the folding area. Accordingly, when the folding of the display device is performed, the considerable space for accommodating (or alternatively, advantageous to accommodate) each of the first frame SF1, the metal plate 100, the panel lower member 200, the display panel 300, the polarizing film 400, the cover window 500, the first adhesive member AD1, the second adhesive member AD2, the third adhesive member AD3, the fourth adhesive member AD4, and the fifth adhesive member AD5 may not be required. In some example embodiments, each of a gap between the lateral portion SC1-S and the first frame SF1, a gap between the lateral portion SC1-S and one end of the metal plate 100, a gap between the lateral portion SC1-S and one end of the panel lower member 200, a gap between the lateral portion SC1-S and one end of the display panel 300, a gap between the lateral portion SC1-S and one end of the polarizing film 400, a gap between the lateral portion SC1-S and one end of the cover window 500, a gap between the lateral portion SC1-S and the first adhesive member AD1, a gap between the lateral portion SC1-S and the second adhesive member AD2, a gap between the lateral portion SC1-S and the third adhesive member AD3, a gap between the lateral portion SC1-S and the fourth adhesive member AD4, and a gap between the lateral portion SC1-S and the fifth adhesive member AD5 may be reduced. Accordingly, the dead space of the display device may be reduced. In some example embodiments, the structure and the like that prevent and/or reduce the considerable spaces from being perceived by users may be omitted.

In some example embodiments, in an example where the display device is folded and unfolded again, the elements of the display unit DU other than the uppermost end may be restored (and/or recovered) back to the state before the slipping. As an example, in an example where the display device is folded and unfolded again, each of the first frame SF1, the metal plate 100, the panel lower member 200, the display panel 300, the polarizing film 400, the cover window 500, the first adhesive member AD1, the second adhesive member AD2, the third adhesive member AD3, the fourth adhesive member AD4, and the fifth adhesive member AD5 may be restored (or recovered) back to the state before the slipping. For example, in the example where the display device is folded and unfolded again, the display unit DU may be restored from the state of the display unit DU shown in FIG. 16 to the state of the display unit DU shown in FIG. 15. In the example where the display device is folded again before the elements of the display unit DU other than the uppermost end are completely restored to the state before the slipping, the elements of the display unit DU may deteriorate and/or creases or cracks may occur in the elements of the display unit DU. According to some example embodiments, the position of the first axis and the position of the second axis are different from each other, and the rotation of the uppermost end of the display unit DU and the rotation of the lowermost end of the display unit DU may be controlled independently of each other. Accordingly, in the example where the display device is folded and unfolded again, the elements of the display unit DU other than the uppermost end may be completely restored to the state before the slipping within a short time or alternatively, a relatively short time. Accordingly, in the example where the display device is folded and unfolded again, the elements of the display unit DU may be prevented from deteriorating, and creases, cracks, and/or the like may be prevented from occurring in the elements of the display unit DU. For example, where the display device is folded and unfolded again, deterioration, creases, cracks, and/or the like may be reduced from occurring in the elements of the display unit DU.

In some example embodiments, a width W2 of the protruding portion PD in the first direction DR1 may be less than the width of the fourth coupling hole AH4 in the first direction DR1. As an example, as shown in FIG. 15, the width W2 of the protruding portion PD in the first direction DR1 may be less than the width W1 of the first portion AH4-A in the first direction DR1. Accordingly, the protruding portion PD may move within the fourth coupling hole AH4. As an example, as shown in FIG. 16, in the case where the display device is folded according to the operation of the hinge assembly, the protruding portion PD may move in the first direction DR1 within the fourth coupling hole AH4. Because the case includes the coupling holes, when the display device is folded and unfolded, the frame may slip in the first direction DR1 and a direction opposite to the first direction DR1. In some example embodiments, as shown in FIG. 6, although the number of coupling holes may be 4, example embodiments are not necessarily limited thereto and, in some example embodiments, the number of coupling holes may be variously modified according to some example embodiments.

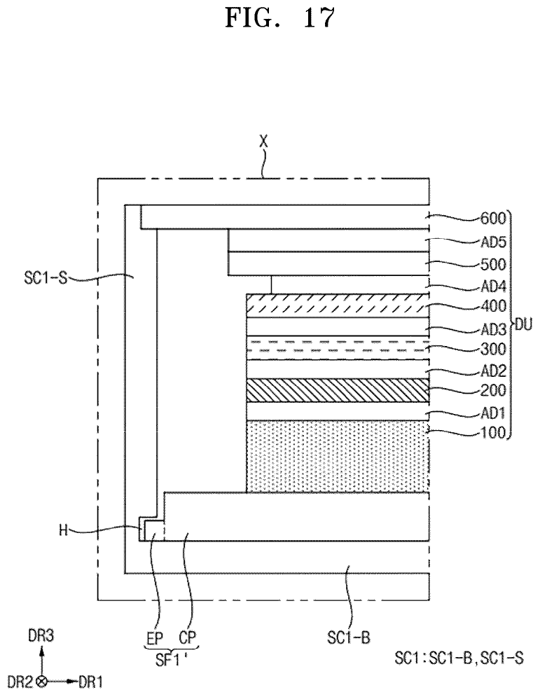

FIG. 17 is an enlarged cross-sectional view of an example of the region X of FIG. 4 according to some example embodiments.

The elements of FIG. 17 are different from the elements of FIG. 15 in only a first frame SF1′. Accordingly, repeated descriptions are omitted or simplified.

Referring to FIG. 17, the first frame SF1′ may have elements substantially corresponding to those of the first frame SF1 of FIG. 15. In some example embodiments, the first frame SF1′ may include a central portion CP and an extension portion EP. The central portion CP may be in contact with the display unit DU. The extension portion EP may extend from the central portion CP. As an example, the extension portion EP may extend from the central portion CP in a direction away from the folding area. As an example, as shown in FIG. 17, the extension portion EP may extend from the central portion CP in a direction opposite to the first direction DR1.

In some example embodiments, the lateral portion SC1-S may include a groove H. The groove H may be a portion obtained by removing at least a portion of the lateral portion SC1-S. The groove H may accommodate at least a portion of the frame (e.g., the frame SF in FIG. 11). As an example, as shown in FIG. 17, the groove H may accommodate at least a portion of the extension portion EP. The extension portion EP may move within the groove H. As an example, in the case where the display device is folded according to the operation of the hinge assembly, the extension portion EP may move toward the folding area within the groove H. Because the case includes the groove H, when the display device is folded and unfolded, the frame may slip in the first direction DR1 and the direction opposite to the first direction DR1.

The display device (e.g., the display device DD in FIG. 1A and the display device DD′ in FIG. 2A) according to some example embodiments may be applied to various electronic devices. The electronic device according to some example embodiments includes the display device and may further include a module and/or a device having another additional function in addition to the display device.

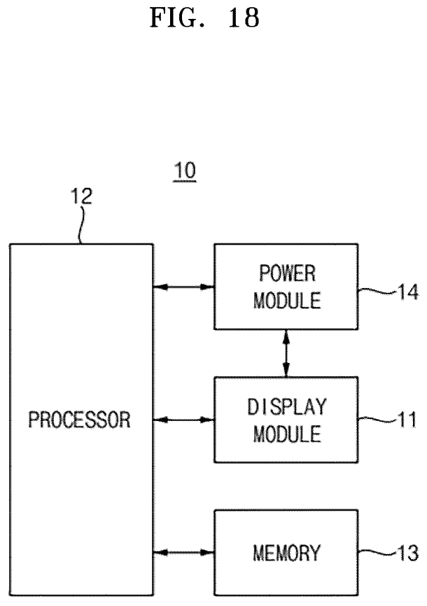

FIG. 18 is a block diagram of an electronic device 10 according to some example embodiments. Referring to FIG. 18, the electronic device 10 according to some example embodiments may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and/or a controller, but example embodiments are not limited thereto.

The memory 13 may store data information for operations of the processor 12 and/or the display module 11. When the processor 12 executes an application stored in the memory 13, image data signals and/or input control signals may be transferred to the display module 11, and the display module 11 may process provided signals and output image information through a display screen.

The power module 14 may include a power supply module such as a power adapter and/or a battery unit, and a power converting module converting power supplied by the power supply module and generating power required or alternatively, advantageous for operations of the electronic device 10.

At least one of the elements of the electronic device 10 may be included in the display device. In some example embodiments, some of individual modules functionally included in one module may be included in the display device, and others may be provided separately from the display device. As an example, the display device may include the display module 11, and the processor 12, the memory 13, and the power module 14 may be provided in the form of another device within the electronic device 10 instead of the display device.

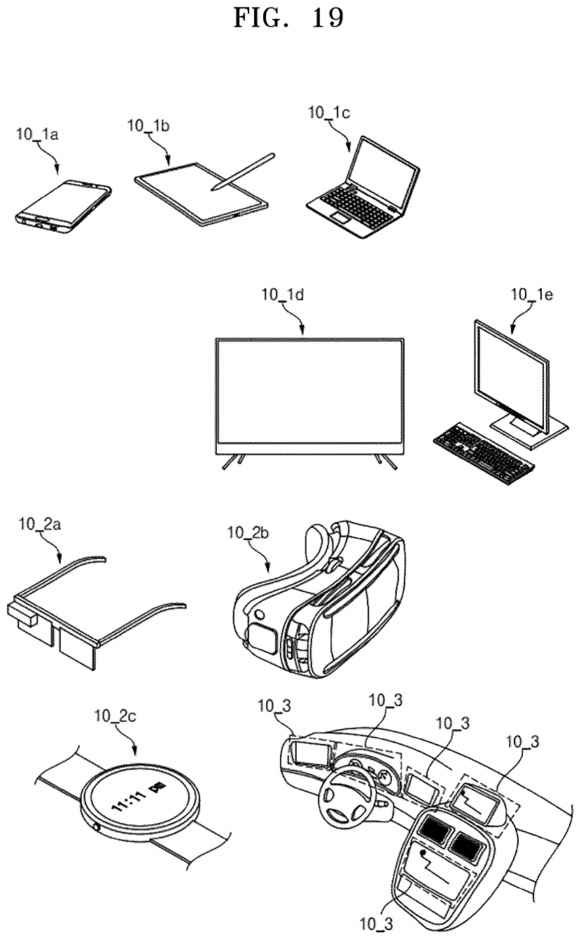

FIG. 19 is a schematic view of electronic devices according to some example embodiments.

Referring to FIG. 19, various electronic devices employing the display device according to the example embodiments may include not only electronic devices for displaying images such as a smartphone 10_1a, a tablet personal computer (PC) 10_1b, a laptop computer 10_1c, a TV 10_1d, and a desktop monitor 10_1e, but also wearable electronic devices including a display module such as a smart glasses 10_2a, a head mount display 10_2b, and a smartwatch 10_2c, and vehicle electronic devices 10_3 including a display module such as an instrument panel of an automobile, a center facia, a center information display (CID) disposed on a dashboard, and a room mirror display.

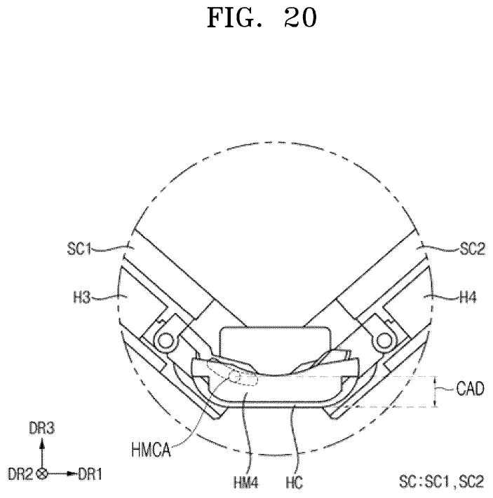

FIG. 20 is a view showing a rotational axis of the fourth hinge module HM4 according to some example embodiments. Referring to FIGS. 1A to 20, case hinge modules HM2 and HM4 may include or denote at least one of the second hinge module HM2 and the fourth hinge module HM4.

As an example, the fourth hinge module HM4 shown in FIG. 20 may be the case hinge modules HM2 and HM4. As an example, the case hinge modules HM2 and HM4 may be connected, coupled, or fixed to the inner surface of the hinge cover HC.

The case SC may rotate about a case rotational axis HMCA formed in the case hinge modules HM2 and HM4. As an example, the first case SC1 and the second case SC2 may respectively rotate about a pair of case rotational axis HMCA to fold and/or unfold.

The case rotational axis HMCA and the hinge cover HC may be apart from each other. As an example, a case rotational axis distance CAD may be a distance between the outer surface of the hinge cover HC and the case rotational axis HMCA. As an example, the case rotational axis distance CAD may be a distance between the outer surface of the hinge cover HC and the case rotational axis HMCA in the third direction DR3.

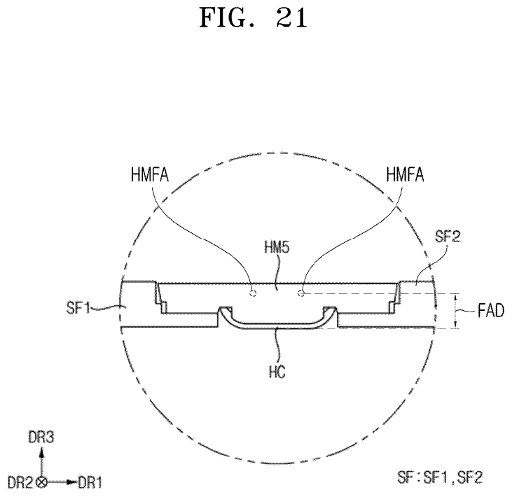

FIG. 21 is a view showing a rotational axis of the fifth hinge module according to some example embodiments. Referring to FIGS. 1A to 21, frame hinge modules HM1, HM3, and HM5 may include or denote at least one of the first hinge module HM1, the third hinge module HM3, and the fifth hinge module HM5.

As an example, the fifth hinge module HM5 shown in FIG. 21 may be the frame hinge modules HM1, HM3, and HM5. As an example, the frame hinge modules HM1, HM3, and HM5 may be connected, coupled, and/or fixed to the inner surface of the hinge cover HC.

The frame SF may rotate about a frame rotational axis HMFA formed in the frame hinge modules HM1, HM3, and HM5. As an example, the first frame SF1 and the second frame SF2 may respectively rotate about a pair of frame rotational axis HMFA to fold and/or unfold.

The frame rotational axis HMFA and the hinge cover HC may be apart from each other. As an example, a frame rotational axis distance FAD may be a distance between the outer surface of the hinge cover HC and the frame rotational axis HMFA. As an example, the frame rotational axis distance FAD may be a distance between the outer surface of the hinge cover HC and the frame rotational axis HMFA in the third direction DR3.

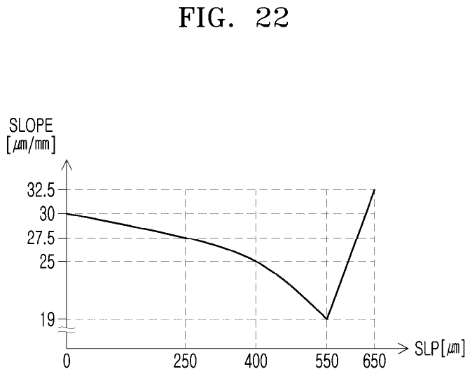

FIG. 22 is a graph showing wrinkles of a display according to an inter-axis distance according to some example embodiments. Referring to FIGS. 1A to 22, the inter-axis distance SLP may be defined as a difference between the case rotational axis distance CAD and the frame rotational axis distance FAD.

The frame rotational axis distance FAD may be equal to or greater than the case rotational axis distance CAD. As an example, the inter-axis distance SLP may be a value obtained by subtracting the case rotational axis distance CAD from the frame rotational axis distance FAD. As an example, the inter-axis distance SLP may be zero or more.

When the display devices DD and DD′ are folded and then unfolded, creases may be formed on the display unit DU. Creases formed on the display unit DU may form a slope SLOPE.

When the slope SLOPE of the creases formed on the display unit DU is large, the visibility of the screen displayed on the display unit DU may be worse due to the creases formed on the display unit DU. For example, when the slope SLOPE of the creases formed on the display unit DU is large, the visibility of the screen displayed on the display unit DU may be reduced due to the creases formed on the display unit DU.

As an example, the slope SLOPE of the creases formed on the display unit DU may be different according to the inter-axis distance SLP. The slope SLOPE shown in FIG. 22 may be measured after the display devices DD and DD′ are unfolded from the folded state.

As an example, in the case SC where the inter-axis distance SLP is 0, the slope SLOPE may be about 30 μm/mm. As an example, in the case SC where the inter-axis distance SLP is about 250 μm, the slope SLOPE may be about 27.5 μm/mm. As an example, in the case SC where the inter-axis distance SLP is about 400 μm, the slope SLOPE may be about 25 μm/mm. As an example, in the case SC where the inter-axis distance SLP is about 550 μm, the slope SLOPE may be about 19 μm/mm. As an example, in the case SC where the inter-axis distance SLP is about 6500 μm, the slope SLOPE may be about 32.5 μm/mm.

As an example, the slope SLOPE of the creases formed on the display unit DU may be relatively low in the case where the inter-axis distance SLP is about 550 μm. As an example, the slope SLOPE of the creases formed on the display unit DU may be relatively low in the case SC where the inter-axis distance SLP is in a range of about 400 μm to about 600 μm.

As an example, when the inter-axis distance SLP is less than 400 μm, the slope SLOPE of the creases formed on the display unit DU may be relatively large. As an example, when the inter-axis distance SLP is greater than 600 μm, the slope SLOPE of the creases formed on the display unit DU may be relatively large.

The end portion of the display unit DU may be connected, coupled, and/or fixed to the case SC. As an example, at least one of the cover window 500 and the protective film 600 may be fixed to the case SC.

The end portion of the frame SF may not be coupled to the case SC. As an example, the end portion of the frame SF may face the case SC and be apart from the case SC.

As an example, a distance between the end portion of the frame SF and the case SC may be different depending on the state of the display devices DD and DD′. As an example, a distance between the end portion of the frame SF and the case SC while the display devices DD and DD′ are folded may be greater than a distance between the end portion of the frame SF and the case SC while the display devices DD and DD′ are unfolded. Accordingly, the creases occurring on the display unit DU may be suppressed and/or reduced.

The thickness of the display unit DU may be about 650 μm. The inter-axis distance SLP may be set relative to the thickness of the display unit DU. As an example, the inter-axis distance SLP may be expressed by a parameter relative to the thickness of the display unit DU.

As an example, an inter-axis ratio may be the inter-axis distance SLP divided by the thickness of the display unit DU. As an example, when the inter-axis ratio is less than 0.615 or greater than 0.923, the slope SLOPE of the creases formed on the display unit DU may be relatively large. As an example, the slope SLOPE of the creases formed on the display unit DU may be relatively low in the case SC where the inter-axis ratio is in a range of about 0.615 to about 0.923.

The display device according to some example embodiments may include: a display unit; a frame supporting the display unit under the display unit; a case accommodating the display unit and the frame; and a hinge assembly including a hinge cover, a first hinge module, and a second hinge module, wherein the first hinge module sits on the hinge cover and is configured to control the rotation of the frame, and the second hinge module sits on the hinge cover and is configured to control the rotation of the case.

Accordingly, the dead space of the display device may be reduced. In some example embodiments, the elements of the display unit may be prevented from deteriorating, and the creases, cracks, and the like may be prevented from occurring on the elements of the display unit. For example, occurrences of deterioration, creasing, cracking, and/or the like of elements of the display unit may be reduced.

As described herein, any devices, electronic devices, modules, units, and/or portions thereof according to any of the example embodiments, and/or any portions thereof may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

Example embodiments of the present inventive concepts are not limited to the above effects but may variously extend without departing from the scope and area of the present inventive concepts.

It should be understood that embodiments described herein should be considered in a descriptive sense only and not for purposes of limitation. Descriptions of features or aspects within each example embodiment should typically be considered as available for other similar features or aspects in other example embodiments. While one or more example embodiments have been described with reference to the figures, it will be understood by those of ordinary skill in the art that various changes in form and details may be made therein without departing from the spirit and scope as defined by the following claims.

1. A display device, comprising:
a display unit;
a frame supporting the display unit, the frame being under the display unit;
a case accommodating the display unit and the frame; and
a hinge assembly including a hinge cover, a first hinge module, and a second hinge module, the first hinge module and the second hinge module being seated on an inner surface of the hinge cover,
the frame is configured to rotate around a frame rotational axis in the first hinge module,
the case is configured to rotate around a case rotational axis in the second hinge module,
an inter-axis distance is in a range of about 400 μm to about 600 μm,
a frame rotational axis distance is defined as a distance between the frame rotational axis and an outer surface of the hinge cover,
a case rotational axis distance is defined as a distance between the case rotational axis and the outer surface of the hinge cover, and
the inter-axis distance is obtained by subtracting the case rotational axis distance from the frame rotational axis distance.

2. The display device of claim 1, wherein the case includes a first case on one side of the hinge cover, and a second case on another side of the hinge cover, and the second hinge module is configured to control a rotation of the first case and a rotation of the second case.

3. The display device of claim 1, wherein the frame includes a first frame on one side of the hinge cover, and a second frame on another side of the hinge cover, and the first hinge module is configured to control a rotation of the first frame and a rotation of the second frame.

4. (canceled)

5. (canceled)

6. (canceled)

7. (canceled)

8. (canceled)

9. The display device of claim 1, wherein the case includes a bottom portion and a lateral portion extending from the bottom portion, and the bottom portion of the case includes a coupling hole that accommodates at least a portion of the frame.

10. The display device of claim 9, wherein the frame includes:
a flat portion in contact with the display unit; and
a protruding portion protruding from the flat portion and accommodated by the coupling hole.

11. The display device of claim 10, wherein a width of the protruding portion in a first direction is less than a width of the coupling hole in the first direction.

12. The display device of claim 11, wherein the protruding portion is configured to move in the first direction within the coupling hole according to a folding operation of the hinge assembly.

13. (canceled)

14. The display device of claim 1, wherein the case includes a bottom portion and a lateral portion extending from the bottom portion, and a planar separation distance between an end of the frame and the lateral portion of the case increases according to a folding operation of the hinge assembly.

15. The display device of claim 14, wherein the display unit includes:
a metal plate;
a display panel attached to an upper surface of the metal plate by a first adhesive member;
a cover window attached to an upper surface of the display panel by a second adhesive member; and
a protective film attached to an upper surface of the cover window by a third adhesive member and fixed to the lateral portion of the case,
wherein, according to the folding operation of the hinge assembly, each of a planar separation distance between an end of the first adhesive member and the lateral portion of the case, a planar separation distance between an end of the second adhesive member and the lateral portion of the case, and a planar separation distance between an end of the third adhesive member and the lateral portion of the case increases.

16. The display device of claim 1, wherein the case includes a bottom portion and a lateral portion extending from the bottom portion, and the lateral portion of the case includes a groove that accommodates at least a portion of the frame.

17. The display device of claim 16, wherein the frame includes:
a central portion in contact with the display unit; and
an extension portion extending from the central portion and accommodated in the groove.

18. The display device of claim 17, wherein the extension portion is configured to move within the groove according to a folding operation of the hinge assembly.

19. The display device of claim 1, wherein the hinge assembly is seated on the hinge cover, and the display device further includes a third hinge module configured to control rotation of the frame.

20. (canceled)

21. A display device comprising:
a display unit;
a frame supporting the display unit, the frame being under the display unit;
a case accommodating the display unit and the frame; and
a hinge assembly including a hinge cover, a first hinge module, and a second hinge module, the first hinge module is seated on an inner surface of the hinge cover, a lowermost end of the display unit is rotatably coupled to the first hinge module, the second hinge module is seated on the inner surface of the hinge cover, and an uppermost end of the display unit is rotatably coupled to the second hinge module,
the frame is configured to rotate around a frame rotational axis in the first hinge module,
the case is configured to rotate around a case rotational axis in the second hinge module,
an inter-axis distance is in a range of about 400 μm to about 600 μm,
a frame rotational axis distance is defined as a distance between the frame rotational axis and an outer surface of the hinge cover,
a case rotational axis distance is defined as a distance between the case rotational axis and the outer surface of the hinge cover, and
the inter-axis distance is obtained by subtracting the case rotational axis distance from the frame rotational axis distance.

22. (canceled)

23. The display device of claim 21, wherein the display unit includes:
a metal plate;
a display panel on the metal plate;
a cover window on the display panel; and
a protective film on the cover window.

24. (canceled)

25. The display device of claim 21, wherein the case and the second hinge module are coupled to each other.

26. The display device of claim 21, wherein the frame and the first hinge module are coupled to each other.

27. An electronic device comprising:
a display unit;
a frame supporting the display unit, the frame being under the display unit;
a case accommodating the display unit and the frame;
a hinge assembly including a hinge cover, a first hinge module, and a second hinge module, the first hinge module is seated on an inner surface of the hinge cover, the frame is rotatably coupled to the first hinge module, the second hinge module is seated on the inner surface of the hinge cover, and the case is rotatably coupled to the second hinge module; and
a memory storing data information,
the frame is configured to rotate around a frame rotational axis in the first hinge module,
the case is configured to rotate around a case rotational axis in the second hinge module,
an inter-axis distance is in a range of about 400 μm to about 600 μm,
a frame rotational axis distance is defined as a distance between the frame rotational axis and an outer surface of the hinge cover,
a case rotational axis distance is defined as a distance between the case rotational axis and the outer surface of the hinge cover, and
the inter-axis distance is obtained by subtracting the case rotational axis distance from the frame rotational axis distance.

28. The electronic device of claim 27, wherein the case includes a first case on one side of the hinge cover, and a second case on another side of the hinge cover, and the second hinge module is configured to control a rotation of the first case and a rotation of the second case.

29. The electronic device of claim 27, wherein the frame includes a first frame on one side of the hinge cover, and a second frame on another side of the hinge cover, and the first hinge module is configured to control a rotation of the first frame and a rotation of the second frame.
